(19) United States
(12) Patent Application Publication
(10) Pub. No.: US 2012/0228155 A1
(43) Pub. Date: Sep. 13, 2012

(54) ELECTROMAGNETIC DETECTION OF ANALYTES

(75) Inventors: Brian H. Clare, Portland, OR (US); Edward J. Etherington, Portland, OR (US)

(73) Assignee: Virogenomics, Inc.

(21) Appl. No.: 13/434,545

(22) Filed: Mar. 29, 2012

Related U.S. Application Data
(63) Continuation-in-part of application No. PCT/US2010/050972, filed on Sep. 30, 2010.
(60) Provisional application No. 61/247,227, filed on Sep. 30, 2009.

(51) Int. Cl. G01N 27/327; B05D 3/10; G01N 27/403

(52) U.S. Cl. 205/777.5; 204/403.01; 427/58

(57) ABSTRACT

Disclosed herein are functionalized electrodes and biosensors that can be used to detect biomolecules, such as a target analyte. In some embodiments, a functionalized electrode includes an electrically conducting surface, a first thiol compound and a second thiol compound. Also provided are kits and biosensor arrays including one or more disclosed functionalized electrodes and/or biosensors. Moreover, systems and methods for detecting biomolecules, such as a target analyte, with the disclosed functionalized electrodes and/or biosensors are also provided.

### CROSS REFERENCE TO RELATED APPLICATIONS

This application is a continuation-in-part of PCT/US2010/050972, filed Sep. 30, 2010, which claims the benefit of U.S. Provisional Application No. 61/247,227, filed Sep. 30, 2009, each of which is incorporated by reference herein in its entirety.

### FIELD

This disclosure concerns functionalized electrodes and specifically, functionalized electrodes composed of non-fouling monolayers deposited on a conducting surface.

### BACKGROUND

Detection and quantification of analytes, such as biomolecules or other molecules that affect biological processes, present in samples are integral to analytical testing. For example, the detection of biomolecules that are markers of biological activity or disease is important for the diagnosis of medical conditions and pathologies. However, converting the detection of an analyte, such as a biomolecule, into a usable signal is challenging in part due to the complexity of transducing the detection event, for example antibodies binding an antigen, into a detectable signal that can be converted into perceivable data. Some assays, such as enzyme linked immunoabsorbant assays (ELISA) detect biomolecules by monitoring the binding event which generates light or a reaction product that produces a color change in the sample. One advantage of these types of assays is that they are very sensitive. However, a drawback of these assays, such as an ELISA assay, is that they typically require long period of time to develop a detectable signal and require multiple steps to complete.

Recently, other methods have been being developed that retain the sensitivity of traditional immunoassays, while eliminating the complexity and time involved in developing the signal. One strategy is to couple the sensitivity of the immunoassay, for example by using highly selective antibodies that have high affinity for analytes, with electrochemical measurements. By combining the detection events to an electric signal, the information about the presence and concentration of an analyte in a sample can be immediately converted to an electrical signal. Over the past decades several sensing concepts and related devices have been developed. The most common traditional techniques include cyclic voltammetry, chronoamperometry, chronopotentiometry, and impedance spectroscopy.

However, the general performance of electrochemical sensors is often determined by the surface architectures that connect the sensing element to the biological sample at the nanometer scale. Electrochemical biosensors have suffered from a lack of surface architectures allowing high enough sensitivity and unique identification of the response with the desired biochemical event.

Thus, the need exists for electrochemical biosensors that have the high sensitivity of traditional assays, such as ELISA assays, while maintaining the desirable aspects of an electrochemical sensor, such as readily measurable signal and the prospects of miniaturization.

### SUMMARY

Herein are provided functionalized electrodes that can be included within electrochemical biosensors which have the high sensitivity associated with a traditional detection assay while simultaneously providing a readily measurable signal.

As such, disclosed herein are functionalized electrodes. In some embodiments, a functionalized electrode includes an electrically conducting surface, a first thiol compound and a second thiol compound. In some examples, the first thiol compound has the formula HS—(CH₂)x-(OCH₂CH₂)y-NH₂, or a salt there of, such as a chloride salt, wherein x is an integer ranging from 1-30 and y is an integer ranging from 0-10, and wherein the first thiol compound is bound to the electrically conducting surface through the reaction of the sulfhydryl moiety and wherein the first thiol is covalently linked to a ligand that specifically binds to a target analyte. In some examples, the second thiol compound has the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group and wherein the second thiol compound is bound to the electrical conducting surface through the reaction of the sulfhydryl moiety.

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

Also provided herein are biosensors. In one embodiment, a biosensor includes a disclosed functionalized electrode. Biosensor arrays including a plurality of disclosed biosensors are also disclosed.

Additionally, kits are disclosed. In some embodiments, a kit includes one or more disclosed functionalized electrodes, one or more disclosed biosensors or a biosensor array and additional reagents for use in detecting a target analyte.

Systems for detecting a target analyte are also provided herein. In some embodiments, a system for detecting a target analyte includes a first electrode (such as a working electrode, for example a disclosed functionalized electrode), a second electrode (such as a common electrode), and an electrochemical instrument (such as an electrochemical instrument including a potentiostat) capable of applying a controlled potential between the first and second electrode and measuring the current between the two electrodes. In some embodiments, a system for detecting a target analyte includes a first electrode (such as a working electrode, for example a functionalized electrode disclosed herein), a second electrode (such as a counter electrode), and a third electrode (such as a reference electrode), and an electrochemical instrument (such as an electrochemical instrument including a potentiostat) capable of applying a controlled potential between two or more of the electrodes in the system and measuring the current between the electrodes.

Also disclosed herein are methods of detecting a target analyte in a sample. In some embodiments, a method of detecting a target analyte includes the following: contacting a sample, such as a fluid sample that includes or is suspected of including the target analyte, with the electrodes of a disclosed system for detecting a target analyte, wherein one of the electrodes is a functionalized electrode that includes a ligand that specifically binds to the target analyte; contacting the electrodes of the system with a detection reagent, wherein the detection reagent includes a specific binding agent that specifically binds to the target analyte, wherein the specific binding agent is not identical to the ligand that specifically binds to the target analyte and wherein the detection reagent includes an enzyme that catalyzes a reaction with an enzyme substrate to produce an electroactive product that is capable of either electron donation or electron acceptance; contacting the electrodes of the system with a the enzyme substrate; and measuring the current between the functionalized electrode and a second electrode in the system, wherein detection of a change in current between the electrodes detects the target analyte in the sample.

In other embodiments, a method of detecting a target analyte in a sample includes the following: contacting a sample with the electrodes of a disclosed system, wherein the system includes a functionalized electrode that includes a ligand that specifically binds to the target analyte; contacting the electrodes of the system with a detection reagent, wherein the detection reagent includes a specific binding agent that specifically binds to the ligand that specifically binds to the target analyte and wherein the detection reagent includes an enzyme that catalyzes a reaction with an enzyme substrate to produce an electroactive product that is capable of either electron donation or electron acceptance; contacting the electrodes of the system with the substrate; and measuring the current between the electrodes in the system, wherein detection of a change in current between the electrodes detects the target analyte in the sample.

Also disclosed are methods of making a functionalized electrode for detecting a target analyte. In some embodiments, a method of making a functionalized electrode includes the following: contacting an electrically conducting surface with a mixture including a first thiol compound having the formula HS—(CH₂)x-(OCH₂CH₂)y-NH₂, or a salt there of, such as a chloride salt, wherein x is an integer ranging from 1-30 and y is an integer ranging from 0-10 and a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group, wherein sulfhydryl groups on the first and second thiol compounds bond with the electrically conducting surface, thereby creating a monolayer on the surface of the electrically conducting surface; contacting the monolayer on the surface of the electrically conducting surface with a heterobifunctional linker, wherein the heterobifunctional linker includes a first chemical moiety that reacts with the NH₂ present on the first thiol compound to form a covalent bond, and wherein the heterobifunctional linker includes a second chemical moiety that reacts with a ligand that specifically binds a target analyte to form a covalent bond between the heterobifunctional linker and ligand, thereby making a functionalized electrode for detecting a target analyte. In some examples, the heterobifunctional linker is sulfo-NHS diazirine (sulfo-SDA), wherein the sulfo-SDA and the NH₂ chemically react to form a covalent bond. In such an example, the monolayer on the surface of the electrically conducting surface is further contacted with a ligand that specifically binds a target analyte and exposed to ultra violet radiation; thereby making a functionalized electrode for detecting a target analyte. In some examples, the first moiety is sulfosuccinimidyl and the second moiety is a maleimide. In specific examples the heterobifunctional linker is sulfosuccinimidyl-4-(N-maleimidomethyl)cyclohexane-1-carboxylate (Sulfo-SMCC).

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

The foregoing and other features of the disclosure will become more apparent from the following detailed description, which proceeds with reference to the accompanying figures.

### BRIEF DESCRIPTION OF THE DRAWINGS

FIG. 1A is a schematic representation of the composition of an exemplary functionalized electrode (working electrode).

FIG. 1B is a schematic representation of the composition of an exemplary functionalized electrode (working electrode), in which the linker is the reaction product of sulfosuccinimidyl-4-(N-maleimidomethyl)cyclohexane-1-carboxylate (Sulfo-SMCC).

FIG. 1C is a schematic representation of the composition of an exemplary functionalized electrode (working electrode), in which the linker is the reaction product of sulfo-NHS diazirine.

FIG. 2A is a block diagram of a two electrode system.

FIG. 2B is a block diagram of a three electrode system.

FIG. 3 is a bar graph showing the results obtained from Example 1 below. The x-axis is the concentration of a monoclonal antibody specific for the protein Phi p5 present in the sample. The y-axis shows the recorded current passing through working electrode in a three electrode configuration, for example, as shown in FIG. 2B. The bar graph shows the current measured is concentration dependent. The errors bars represent the standard error over three replicates.

FIG. 4 is a bar graph showing the results obtained from Example 2 below. The x-axis is the concentration of a monoclonal antibody specific for the protein gliadin present in the sample. The y-axis shows the recorded current passing through working electrode in a three electrode configuration, for example as shown in FIG. 2B. The bar graph shows the current measured is concentration dependent. The errors bars represent the standard error over three replicates.

FIG. 5 is a graph of the electrochemical detection of IL-10 using the biosensors described in Example 5 compared against a commercial enzyme-linked immunosorbent assay (ELISA) kit for detection in 1:100 dilution of normal human serum dosed with analyte. As shown in the graph, the electrochemical detection method is comparable in sensitivity to the commercially available ELISA kit.

FIG. 6 is a bar graph showing the results of an assay using the biosensor prepared according to Example 2 in a 15 minute ligand binding assay that includes the reporter step.

FIG. 7 is a bar graph showing the comparison of the sensitivity of biosensors prepared using the disclosed methods (Diazirine_EG SAMS) and alternative methods of constructing monolayers. As shown in the graph, the biosensors produced with the disclosed methods are significantly superior in sensitivity as compared to biosensors produced by alternative methods.

FIG. 8 is a schematic representation of methods of detecting analytes in solution using the disclosed biosensors.

FIG. 9 is a graph of exemplary amperometric detection of an analyte using the working electrodes produced according to Example 7 below. The ligand was a peptide with a sequence homologous to part of the protein gliadin. Antibodies with affinity to gliadin bind to the surface. Antibodies that do not have affinity to gliadin, in this example anti-derPi, antibodies do not bind to the electrode surface. A secondary reagent, an anti-antibody HRP conjugate, was used as the secondary reporter reagent. The substrate was TMB and H₂O₂ which was injected into the electrochemical cell at 40, 80 and 120 seconds. Each time the substrate was injected into the cell with electrodes that had been exposed to biological solutions containing anti-gliadin antibodies a strong amperometric signal was measured.

FIG. 10 is a bar graph showing the results obtained from Example 7 below. The x-axis is the concentration of a monoclonal antibody specific for the protein gliadin present in the sample. The y-axis shows the recorded current passing through working electrode in a three electrode configuration, for example as shown in FIG. 2B. The bar graph shows the current measured is concentration dependent. The errors bars represent the standard error over three replicates.

FIGS. 11A-11C is a set of graphs of cyclic voltammetry tests to select specific electroactive substrates for use in the disclosed functionalized electrodes.

FIG. 12 is a schematic representation of an exemplary method of detecting biological molecules using a secondary reagent and the disclosed functionalized electrodes.

FIG. 13 is a schematic representation of an exemplary method of detecting biological molecules using competing reporters and the disclosed functionalized electrodes.

FIG. 14A is a graph showing a linear relationship between signal and analyte (human IgE) concentration. Anti-IgE was attached to sensor surfaces and used to create a calibration curve by exposing the sensors to human serum depleted of IgE. IgE was spiked into solutions at known concentrations to create a linear equation that related the x coordinate, IgE concentration (ng/mL), and the y coordinate, signal (uAmps).

FIG. 14B is a bar graph showing detection of three different allergens (Phl p5, Alt a1, and Fel d1) using the disclosed methods and biosensors. The x-axis shows the three allergens. The y-axis is the concentration of allergen-specific IgE in human serum samples. Sensor arrays were prepared with allergens Phl p5 (grass allergen), Alt a1 (mold allergen), or Fel d1 (cat allergen) attached to sensor surfaces. Human serum from people with allergies was diluted 1:2 in PBST and incubated on the sensors for 10 minutes. The calibration curve shown in FIG. 14A was used to convert the signal (uAmps) into concentration of allergen specific IgE (ng/mL).

### SEQUENCE LISTING

The amino acid sequence listed in the accompanying sequence listing are shown using standard three letter code for amino acids, as defined in 37 C.F.R. 1.822. In the accompanying sequence listing:

SEQ ID NO: 1 is the amino acid sequence of an epitope from the wheat protein gliadin.

The Sequence Listing is submitted as an ASCII text file in the form of the file named Sequence_Listing.txt, which was created on Mar. 14, 2012, and is 664 bytes, which is incorporated by reference herein.

### DETAILED DESCRIPTION

### I. Listing of Terms

Unless otherwise noted, technical terms are used according to conventional usage. Definitions of common terms in molecular biology may be found in Benjamin Lewin, Genes VII, published by Oxford University Press, 2000 (ISBN 019879276X); Kendrew et al. (eds.), The Encyclopedia of Molecular Biology, published by Blackwell Publishers, 1994 (ISBN 0632021829); and Robert A. Meyers (ed.), Molecular Biology and Biotechnology: a Comprehensive Desk Reference, published by Wiley, John & Sons, Inc., 1995 (ISBN 0471186341); and other similar references.

As used herein, the singular terms “a,” “an,” and “the” include plural referents unless context clearly indicates otherwise. Similarly, the word “or” is intended to include “and” unless the context clearly indicates otherwise. Also, as used herein, the term “comprises” means “includes.” Hence “comprising A or B” means including A, B, or A and B. It is further to be understood that all nucleotide sizes or amino acid sizes, and all molecular weight or molecular mass values, given for nucleic acids or polypeptides or other compounds are approximate, and are provided for description. Although methods and materials similar or equivalent to those described herein can be used in the practice or testing of the present disclosure, suitable methods and materials are described below. In case of conflict, the present specification, including explanations of terms, will control. In addition, the materials, methods, and examples are illustrative only and not intended to be limiting.

To facilitate review of the various examples of this disclosure, the following explanations of specific terms are provided:

Allergen: A nonparasitic antigen capable of stimulating a type-I hypersensitivity reaction. Type I allergy is the production of immunoglobulin E (IgE) antibodies against otherwise harmless antigens, termed allergens, which can originate from a multitude of allergen sources (e.g., mites, plant pollens, animals, insects, molds, and food). IgE-mediated presentation of allergens to T cells leads to T-cell activation and chronic allergic inflammation (e.g., chronic asthma, atopic dermatitis), particularly after repeated contact with allergens. This event also induces increases of allergen-specific serum IgE levels and patients. Common allergens include: those derived from plants, such as trees, for example Betula verrucosa allergens Bet v 1, Bet v 2, and Bet v 4; Juniperous oxycedrus allergen Jun o 2; Castanea sativa allergen Cas s 2; and Hevea brasiliensis allergens Hev b 1, Hev b 3, Hev b 8, Hev b 9, Hev b 10 and Hev b 11; grasses, such as Phleum pretense allergens Phl p 1, Phl p 2, Phl p 4, Phl p 5a, Phl p 5, Phl p 6, Phl p 7, Phl p 11, and Phl p 12; weeds, such as Parietaria judaica allergen Par j 2.01011; and Artemisia vulgaris allergens Art v 1 and Art v 3; Mites, such as Dermatophagoides pteronyssinus allergens Der p 1, Der p 2, Der p 5, Der p 7, Der p 8, and Der p 10; Tyrophagu putrescentiae allergen Tyr p 2; Lepidoglyphus destructor allergens Lep d 2.01 and Lep d 13; and Euroglyphus maynei allergen Eur m 2.0101; animals, such as cats, for example Felis domesticus allergen Fel d 1; Penaeus aztecus allergen Pen a 1; Cyprinus carpo allergen Cyp c 1; and albumin from cat, dog, cattle, mouse, rat, pig, sheep, chicken, rabbit, hamster, horse, pigeon, and guinea pig; Fungi, such as Penicillium citrinum allergens Pen c 3 and Pen c 19; Penicillium notatum allergen Pen n 13; Aspergillus fumigatus allergens Asp f 1, Asp f3, Asp f 4, Asp f 6, Asp f 7 and Asp f 8; Alternaria alternata allergens Alt a 1 and Alt a 5; Malassezia furfur allergen Mal f 1, Mal f 5, Mal f 6, Mal f 7, Mal f 8, and Mal f 9; insects, such as Blatella germanica allergens Bla g 2, Bla g 4, and Bla g 5; Apis mellifera allergens Api m 2 and Api m 1; Vespula vulgaris allergen Ves v 5; Vespula germanica allergen Ves g 5; and Polstes annularis allergen Pol a 5; food, such as Malus domestica allergens Mal d 1 and Mal d 2; Apium graveolens allergend Api g 1 and Api g 1.0201; Daucus carota allergen Dau c 1; and Arachis hypogaea allergens Ara h 2 and Ara h 5 and the like. In some embodiments, an allergen or portion thereof is part of a functionalized electrode, thus a disclosed functionalized electrode can be used to measure the presence and concentration of antibodies in a sample that specifically bind an allergen. In some embodiments, an antibody that specifically binds an allergen or portion thereof is part of a disclosed functionalized electrode, thus a disclosed functionalized electrode can be used to measure the presence and concentration of an allergen.

Antibody: “Antibody” collectively refers to immunoglobulins or immunoglobulin-like molecules (including by way of example and without limitation, IgA, IgD, IgE, IgG and IgM, combinations thereof), and similar molecules produced during an immune response in any chordate such as a vertebrate, for example, in mammals such as humans, goats, rabbits and mice and fragments thereof that specifically bind to a molecule of interest (or a group of highly similar molecules of interest) to the substantial exclusion of binding to other molecules. An “antibody” typically comprises a polypeptide ligand having at least a light chain or heavy chain immunoglobulin variable region that specifically recognizes and binds an epitope of an antigen. Exemplary antibodies include polyclonal and monoclonal antibodies.

Immunoglobulins are composed of a heavy and a light chain, each of which has a variable region, termed the variable heavy (VH) region and the variable light (VL) region. Together, the VH region and the VL region are responsible for binding the antigen recognized by the immunoglobulin. Exemplary immunoglobulin fragments include, without limitation, proteolytic immunoglobulin fragments (such as F(ab′)2 fragments, Fab′ fragments, Fab′-SH fragments and Fab fragments as are known in the art), recombinant immunoglobulin fragments (such as sFv fragments, dsFv fragments, bispecific sFv fragments, bispecific dsFv fragments, F(ab)′2 fragments), single chain Fv proteins (“scFv”), and disulfide stabilized Fv proteins (“dsFv”). Other examples of antibodies include diabodies, and triabodies (as are known in the art), and camelid antibodies. “Antibody” also includes genetically engineered molecules, such as chimeric antibodies (for example, humanized murine antibodies), and heteroconjugate antibodies (such as, bispecific antibodies). See also, Pierce Catalog and Handbook, 1994-1995 (Pierce Chemical Co., Rockford, Ill.); Kuby, J., Immunology, 3rd Ed., W.H. Freeman & Co., New York, 1997.

Each heavy and light chain contains a constant region and a variable region, (the regions are also known as “domains”). In combination, the heavy and the light chain variable regions specifically bind the antigen. Light and heavy chain variable regions contain a “framework” region interrupted by three hypervariable regions, also called “complementarity-determining regions” or “CDRs.” The extent of the framework region and CDRs have been defined (see, Kabat et al., (1991) Sequences of Proteins of Immunological Interest, 5th Edition, U.S. Department of Health and Human Services, Public Health Service, National Institutes of Health, Bethesda, Md. (NIH Publication No. 91-3242) which is hereby incorporated by reference). The Kabat database is now maintained online. The sequences of the framework regions of different light or heavy chains are relatively conserved within a species. The framework region of an antibody, that is the combined framework regions of the constituent light and heavy chains, serves to position and align the CDRs in three-dimensional space, for example to hold the CDRs in an appropriate orientation for antigen binding.

The CDRs are primarily responsible for binding to an epitope of an antigen. The CDRs of each chain are typically referred to as CDR1, CDR2 and CDR3, numbered sequentially starting from the N-terminus and are also typically identified by the chain in which the particular CDR is located. Thus, a VH CDR3 is located in the variable domain of the heavy chain of the antibody in which it is found, whereas a VL CDR1 is the CDR1 from the variable domain of the light chain of the antibody in which it is found.

A “monoclonal antibody” is an antibody produced by a single clone of B-lymphocytes or by a cell into which the light and heavy chain genes of a single antibody have been transfected or transduced. Monoclonal antibodies are produced by methods known to those of skill in the art, for instance by making hybrid antibody-forming cells from a fusion of myeloma cells with immune spleen cells. These fused cells and their progeny are termed “hybridomas.” Monoclonal antibodies include humanized monoclonal antibodies.

A “humanized” immunoglobulin, is an immunoglobulin including a human framework region and one or more CDRs from a non-human (such as a mouse, rat or synthetic) immunoglobulin. The non-human immunoglobulin providing the CDRs is termed a “donor,” and the human immunoglobulin providing the framework is termed an “acceptor.” In one embodiment, all the CDRs are from the donor immunoglobulin in a humanized immunoglobulin. Constant regions need not be present, but if they are, they must be substantially identical to human immunoglobulin constant regions, for example at least about 85-90%, such as about 95% or more identical. Hence, all parts of a humanized immunoglobulin, except possibly the CDRs, are substantially identical to corresponding parts of natural human immunoglobulin sequences. A “humanized antibody” is an antibody comprising a humanized light chain and a humanized heavy chain immunoglobulin. A humanized antibody binds to the same antigen as the donor antibody that provides the CDRs. The acceptor framework of a humanized immunoglobulin or antibody may have a limited number of substitutions by amino acids taken from the donor framework. Humanized or other monoclonal antibodies can have additional conservative amino acid substitutions which have substantially no effect on antigen binding or other immunoglobulin functions. Humanized immunoglobulins can be constructed by means of genetic engineering (for example see U.S. Pat. No. 5,585,089).

In some embodiments, an antibody specifically binds an antigen of interest, such as an antigen that is part of a disclosed functionalized electrode, for example covalently bonded to a thiol compound or a functionalized thiol compound that itself is bonded to an electrode surface. In some embodiments, an antibody specific for an antigen of interest is part of a disclosed functionalized electrode for example covalently bonded to a thiol compound or a functionalized thiol compound that itself is bonded to an electrode surface. In some embodiments, an antibody is part of a detection reagent that includes an enzyme.

Antigen: A compound, composition, or substance that may be specifically bound by the products of specific humoral or cellular immunity, such as an antibody molecule or T-cell receptor. Antigens can be any type of molecule including, for example, haptens, simple intermediary metabolites, sugars (e.g., oligosaccharides), lipids, and hormones as well as macromolecules such as complex carbohydrates (e.g., polysaccharides), phospholipids, nucleic acids and proteins. Common categories of antigens include, but are not limited to, viral antigens, bacterial antigens, fungal antigens, protozoa and other parasitic antigens, tumor antigens, antigens involved in autoimmune disease, allergy and graft rejection, toxins, and other antigens known in the art.

In some embodiments, an antigen is a ligand for an antibody of interest, such as an antibody that is part of a disclosed functionalized electrode, for example covalently bonded to a thiol compound or a functionalized thiol compound that itself is bonded to an electrode surface. In some embodiments, an antigen of interest is part of a disclosed functionalized electrode, for example covalently bonded to a thiol compound or a functionalized thiol compound that itself is bonded to an electrode surface.

Aptamer: Small nucleic acid and peptide molecules that bind a specific target molecule, such as a target biomolecule, for example an analyte, such as a target analyte. In some examples an aptamer is part of a disclosed functionalized electrode.

Bacterial pathogen: A bacteria that causes disease (pathogenic bacteria). Examples of pathogenic bacteria from which antigens for use in the disclosed functionalized electrodes can be derived include without limitation any one or more of (or any combination of) Acinetobacter baumanii, Actinobacillus sp., Actinomycetes, Actinomyces sp. (such as Actinomyces israelii and Actinomyces naeslundii), Aeromonas sp. (such as Aeromonas hydrophila, Aeromonas veronii biovar sobria (Aeromonas sobria), and Aeromonas caviae), Anaplasma phagocytophilum, Alcaligenes xylosoxidans, Acinetobacter baumanii, Actinobacillus actinomycetemcomitans, Bacillus sp. (such as Bacillus anthracis, Bacillus cereus, Bacillus subtilis, Bacillus thuringiensis, and Bacillus stearothermophilus), Bacteroides sp. (such as Bacteroides fragilis), Bartonella sp. (such as Bartonella bacilliformis and Bartonella henselae, Bifidobacterium sp., Bordetella sp. (such as Bordetella pertussis, Bordetella parapertussis, and Bordetella bronchiseptica), Borrelia sp. (such as Borrelia recurrentis, and Borrelia burgdorferi), Brucella sp. (such as Brucella abortus, Brucella canis, Brucella melintensis and Brucella suis), Burkholderia sp. (such as Burkholderia pseudomallei and Burkholderia cepacia), Campylobacter sp. (such as Campylobacter jejuni, Campylobacter coli, Campylobacter lari and Campylobacter fetus), Capnocytophaga sp., Cardiobacterium hominis, Chlamydia trachomatis, Chlamydophila pneumoniae, Chlamydophila psittaci, Citrobacter sp. Coxiella burnetii, Corynebacterium sp. (such as, Corynebacterium diphtheriae, Corynebacterium jeikeum and Corynebacterium), Clostridium sp. (such as Clostridium perfringens, Clostridium difficile, Clostridium botulinum and Clostridium tetani), Eikenella corrodens, Enterobacter sp. (such as Enterobacter aerogenes, Enterobacter agglomerans, Enterobacter cloacae and Escherichia coli, including opportunistic Escherichia coli, such as enterotoxigenic E. coli, enteroinvasive E. coli, enteropathogenic E. coli, enterohemorrhagic E. coli, enteroaggregative E. coli and uropathogenic E. coli) Enterococcus sp. (such as Enterococcus faecalis and Enterococcus faecium) Ehrlichia sp. (such as Ehrlichia chafeensia and Ehrlichia canis), Erysipelothrix rhusiopathiae, Eubacterium sp., Francisella tularensis, Fusobacterium nucleatum, Gardnerella vaginalis, Gemella morbillorum, Haemophilus sp. (such as Haemophilus influenzae, Haemophilus ducreyi, Haemophilus aegyptius, Haemophilus parainfluenzae, Haemophilus haemolyticus and Haemophilus parahaemolyticus, Helicobacter sp. (such as Helicobacter pylori, Helicobacter cinaedi and Helicobacter fennelliae), Kingella kingii, Klebsiella sp. (such as Klebsiella pneumoniae, Klebsiella granulomatis and Klebsiella oxytoca), Lactobacillus sp., Listeria monocytogenes, Leptospira interrogans, Legionella pneumophila, Leptospira interrogans, Peptostreptococcus sp., Moraxella catarrhalis, Morganella sp., Mobiluncus sp., Micrococcus sp., Mycobacterium sp. (such as Mycobacterium leprae, Mycobacterium tuberculosis, Mycobacterium intracellulare, Mycobacterium avium, Mycobacterium bovis, and Mycobacterium marinum), Mycoplasm sp. (such as Mycoplasma pneumoniae, Mycoplasma hominis, and Mycoplasma genitalium), Nocardia sp. (such as Nocardia asteroides, Nocardia cyriacigeorgica and Nocardia brasiliensis), Neisseria sp. (such as Neisseria gonorrhoeae and Neisseria meningitidis), Pasteurella multocida, Plesiomonas shigelloides. Prevotella sp., Porphyromonas sp., Prevotella melaminogenica, Proteus sp. (such as Proteus vulgaris and Proteus mirabilis), Providencia sp. (such as Providencia alcalifaciens, Providencia rettgeri and Providencia stuartii), Pseudomonas aeruginosa, Propionibacterium acnes, Rhodococcus equi, Rickettsia sp. (such as Rickettsia rickettsii, Rickettsia akari and Rickettsia prowazekii, Orientia tsutsugamushi (formerly: Rickettsia tsutsugamushi) and Rickettsia typhi), Rhodococcus sp., Serratia marcescens, Stenotrophomonas maltophilia, Salmonella sp. (such as Salmonella enterica, Salmonella typhi, Salmonella paratyphi, Salmonella enteritidis, Salmonella cholerasuis and Salmonella typhimurium), Serratia sp. (such as Serratia marcesans and Serratia liquifaciens), Shigella sp. (such as Shigella dysenteriae, Shigella flexneri, Shigella boydii and Shigella sonnei), Staphylococcus sp. (such as Staphylococcus aureus, Staphylococcus epidermidis, Staphylococcus hemolyticus, Staphylococcus saprophyticus), Streptococcus sp. (such as Streptococcus pneumoniae (for example chloramphenicol-resistant serotype 4 Streptococcus pneumoniae, spectinomycin-resistant serotype 6B Streptococcus pneumoniae, streptomycin-resistant serotype 9V Streptococcus pneumoniae, erythromycin-resistant serotype 14 Streptococcus pneumoniae, optochin-resistant serotype 14 Streptococcus pneumoniae, rifampicin-resistant serotype 18C Streptococcus pneumoniae, tetracycline-resistant serotype 19F Streptococcus pneumoniae, penicillin-resistant serotype 19F Streptococcus pneumoniae, and trimethoprim-resistant serotype 23F Streptococcus pneumoniae, chloramphenicol-resistant serotype 4 Streptococcus pneumoniae, spectinomycin-resistant serotype 6B Streptococcus pneumoniae, streptomycin-resistant serotype 9V Streptococcus pneumoniae, optochin-resistant serotype 14 Streptococcus pneumoniae, rifampicin-resistant serotype 18C Streptococcus pneumoniae, penicillin-resistant serotype 19F Streptococcus pneumoniae, or trimethoprim-resistant serotype 23F Streptococcus pneumoniae), Streptococcus agalactiae, Streptococcus mutans, Streptococcus pyogenes, Group A streptococci, Streptococcus pyogenes, Group B streptococci, Streptococcus agalactiae, Group C streptococci, Streptococcus anginosus, Streptococcus equismilis, Group D streptococci, Streptococcus bovis, Group F streptococci, and Streptococcus anginosus Group G streptococci), Spirillum minus, Streptobacillus moniliformi, Treponema sp. (such as Treponema carateum, Treponema petenue, Treponema pallidum and Treponema endemicum, Tropheryma whippelii, Ureaplasma urealyticum, Veillonella sp., Vibrio sp. (such as Vibrio cholerae, Vibrio parahemolyticus, Vibrio vulnificus, Vibrio parahaemolyticus, Vibrio vulnificus, Vibrio alginolyticus, Vibrio mimicus, Vibrio hollisae, Vibrio fluvialis, Vibrio metchnikovii, Vibrio damsela and Vibrio furnisii), Yersinia sp. (such as Yersinia enterocolitica, Yersinia pestis, and Yersinia pseudotuberculosis) and Xanthomonas maltophilia among others.

Bacterial antigens suitable for use in the disclosed methods and compositions include proteins, polysaccharides, lipopolysaccharides, and outer membrane vesicles which may be isolated, purified or derived from a bacterium. In addition, bacterial antigens include bacterial lysates and inactivated bacteria formulations. Bacteria antigens can be produced by recombinant expression. Bacterial antigens preferably include epitopes which are exposed on the surface of the bacteria during at least one stage of its life cycle. Bacterial antigens include but are not limited to antigens derived from one or more of the bacteria set forth above as well as the specific antigens examples identified below.

Neiserria gonorrhoeae antigens include Por (or porn) protein, such as PorB (see, e.g., Zhu et al. (2004) Vaccine 22:660-669), a transferring binding protein, such as TbpA and TbpB (see, e.g., Price et al. (2004) Infect. Immun. 71(1):277-283), an opacity protein (such as Opa), a reduction-modifiable protein (Rmp), and outer membrane vesicle (OMV) preparations (see, e.g., Plante et al. (2000) J. Infect. Dis. 182:848-855); WO 99/24578; WO 99/36544; WO 99/57280; and WO 02/079243, all of which are incorporated by reference).

Chlamydia trachomatis antigens include antigens derived from serotypes A, B, Ba and C (agents of trachoma, a cause of blindness), serotypes Li, L3 (associated with Lymphogranuloma venereum), and serotypes, D-K. Chlamydia trachomas antigens also include antigens identified in WO 00/37494; WO 03/049762; WO 03/068811; and WO 05/002619 (all of which are incorporated by reference), including PepA (CT045), LcrE (CT089), Art (CT381), DnaK (CT396), CT398, OmpH-like (CT242), L7/L12 (CT316), OmcA (CT444), AtosS (CT467), CT547, Eno (CT587), HrtA (CT823), MurG (CT761), CT396 and CT761, and specific combinations of these antigens.

Treponema pallidum (Syphilis) antigens include TmpA antigen.

The compositions of the disclosure can include one or more antigens derived from a sexually transmitted disease (STD). Such antigens can provide for prophylactis or therapy for STDs such as chlamydia, genital herpes, hepatitis (such as HCV), genital warts, gonorrhea, syphilis and/or chancroid (see WO 00/15255, which is incorporated by reference). Antigens may be derived from one or more viral or bacterial STDs. Viral STD antigens for use in the invention may be derived from, for example, HIV, herpes simplex virus (HSV-I and HSV-2), human papillomavirus (HPV), and hepatitis (HCV). Bacterial STD antigens for use in the invention may be derived from, for example, Neiserria gonorrhoeae, Chlamydia trachomatis, Treponema pallidum, Haemophilus ducreyi, E. coli, and Streptococcus agalactiae.

In some embodiments, a disclosed functionalized electrode includes one or more antigens derived from one or more of the organisms listed above. In some embodiments, an antibody that specifically binds antigens derived from one or more of the organisms listed above is part of a disclosed functionalized electrode, and thus in some examples can be used to detect such antigens in a sample, for example to diagnose a particular bacterial infection.

Binding affinity: Affinity of a specific binding agent for its target, such as an antibody for an antigen, for example an antibody for a target analyte, such as a target analyte. In one embodiment, affinity is calculated by a modification of the Scatchard method described by Frankel et al., Mol. Immunol., 16:101-106, 1979. In another embodiment, binding affinity is measured by a specific binding agent receptor dissociation rate. In yet another embodiment, a high binding affinity is measured by a competition radioimmunoassay. In several examples, a high binding affinity is at least about 1×10-8 M. In other embodiments, a high binding affinity is at least about 1.5×10-8, at least about 2.0×10-8, at least about 2.5×10-8, at least about 3.0×10-8, at least about 3.5×10-8, at least about 4.0×10-8, at least about 4.5×10-8 or at least about 5.0×10-8 M.

Biomolecule: Any molecule that was derived from biological system, including but not limited to, a synthetic or naturally occurring protein, glycoprotein, lipoprotein, amino acid, nucleoside, nucleotide, nucleic acid, oligonucleotide, DNA, RNA, carbohydrate, sugar, lipid, fatty acid, hapten, and the like. In some examples, a biomolecule is a target analyte for which the presence and or concentration or amount can be determined. In some embodiments a biomolecule is covalently bonded to a thiol compound, and/or a linker, such as a thiol compound that is part of a disclosed functionalized electrode.

Chemokines: Proteins classified according to shared structural characteristics such as small size (approximately 8-10 kilodaltons (kD) in size) and the presence of four cysteine residues in conserved locations that are key to forming their 3-dimensional shape. These proteins exert their biological effects by interacting with G protein-linked transmembrane receptors called chemokine receptors that are selectively found on the surfaces of their target cells. Chemokines bind to chemokine receptors and thus are chemokine receptor ligands.

Examples of chemokines include the CCL chemokines such as CCL1, CCL2, CCL3, CCL4, CCL5, CCL6, CCL7, CCL8, CCL9, CCL10, CCL11, CCL12, CCL13, CCL14, CCL15, CCL16, CCL17, CCL18, CCL19, CCL20, CCL21, CCL22, CCL23, CCL24, CCL25, CCL26, CCL27 and CCL28; CXCL chemokines such as CXCL1, CXCL2, CXCL3, CXCL4, CXCL5, CXCL6, CXCL7, CXCL8, CXCL9, CXCL10, CXCL11, CXCL12, CXCL13, CXCL14, CXCL15, CXCL16 and CXCL17; XCL chemokines such as XCL1 and XCL2; and CX3CL chemokines such as CX3CL1. In some embodiments, a chemokine or portion thereof is part of a disclosed functionalized electrode. In some embodiments, an antibody that specifically binds a chemokine or portion thereof is part of a functionalized electrode, and thus in some examples can be used to detect such chemokines in a sample.

Conjugating, joining, bonding or linking: Coupling a first unit to a second unit. This includes, but is not limited to, covalently bonding one molecule to another molecule, noncovalently bonding one molecule to another (e.g., electrostatically bonding), non-covalently bonding one molecule to another molecule by hydrogen bonding, non-covalently bonding one molecule to another molecule by van der Waals forces, and any and all combinations of such couplings. In some embodiments a ligand for a target analyte is covalently bonded to a thiol compound, and/or a linker.

Contacting: Placement in direct physical association including both in solid or liquid form.

Control: A reference standard. In some examples, a control can be a known value indicative of a known concentration or amount of an analyte, such as a target analyte for example a biomolecule of interest. In some examples a control, or a set of controls of known concentration or amount can be used to calibrate a functionalized electrode.

A difference between a test sample and a control can be an increase or conversely a decrease. The difference can be a qualitative difference or a quantitative difference, for example a statistically significant difference. In some examples, a difference is an increase or decrease, relative to a control, of at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater than 500%.

Complex (complexed): Two proteins, or fragments or derivatives thereof, one protein (or fragment or derivative) and a non-protein compound, molecule or any two or more compounds are said to form a complex when they measurably associate with each other in a specific manner. In some examples, a complex is the complex formed between a functionalized electrode and a target analyte.

Covalent bond: An interatomic bond between two atoms, characterized by the sharing of one or more pairs of electrons by the atoms. The terms “covalently bound” or “covalently linked” refer to making two separate molecules into one contiguous molecule, for example ligand specific for a target analyte and a thiol compound can be covalently linked (such as directly or indirectly through a linker).

Crosslinker: A homo- or hetero-multifunctional reagent with at least two identical or non-identical groups that are reactive to functional group present in proteins, such as sulfhydryls and/or amine groups. In some examples, a protein cross-linker is amine reactive, meaning it is capable of forming a covalent bond with an amine group, such as an amine group present in a protein, for example amine group present on a lysine residue, or for example amine group present in monolayers present in a disclosed functionalized electrode.

Examples of amine reactive groups include aryl azides, carbodiimides, phosphines, imidoesters, N-hydroxysuccinimide-esters (NHS-esters) pentafluorophenyl-esters (PFP-esters), and vinyl sulfones amongst others. In some examples, a protein cross-linker is sulfhydryl reactive, meaning it is capable of forming a covalent bond with sulfhydryl, such as a sulfhydryl group present in protein, for example a sulfhydryl group present on a cysteine residue. Examples of sulfhydryl reactive groups include maleimides, pyridyl disulfides, and vinyl sulfones amongst others. In some examples, a protein cross-linker is carboxylic acid reactive, meaning it is capable of forming a covalent bond with a carboxylic acid group, such as carboxylic acid group present in a protein, for example a carboxylic acid group present in an aspartic acid or glutamic acid residue. Examples of carboxylic acid reactive groups include carbodiimides amongst others.

Examples of cross-linkers that can be used in the disclosed methods and compositions include without limitation bis(sulfosuccinimidyl)suberate (BS3), bis[2-(succinimidooxycarbonyloxy)ethyl]sulfone, dimethyl adipimidate (DMA), dimethyl pimelimidate (DMP), dimethyl suberimidate (DMS), disuccinimidyl glutarate (DSG), dithiobis(succinimidyl)propionate (DSP), disuccinimidyl tartrate (DST), dimethyl 3,3′-dithiobispropionimidate (DTBP), 3,3′-dithiobis(sulfosuccinimidylpropionate) (DTSSP), tris(succinimidyl)aminotriacetate (TSAT), EGS, Sulfo-EGS, molecules with hydroxymethyl phosphine functional groups such as THP, sulfhydryl reactive groups, such as maleimides, for example 1,4-bis(maleimido)butane (BMB), 1,4 bis-maleimidyl-2,3-dihydroxybutane (BMDB), bismaleimidohexane (BMH), bis-maleimidoethane (BMOE), dithio-bismaleimidoethane (DTME) sulfosuccinimidyl 4-N-maleimidomethyl cyclohexane-1-carboxylate (Sulfo-SMCC), and sulfosuccinimidyl 4-N-maleimidomethyl cyclohexane-1-carboxylate (SMCC), 1,4-Di-[3′-(2′-pyridyldithio)-propionamido]butane (DPDPB), sulfones such as 1,6-hexane-bis-vinylsulfone (HBVS), (tris[2-maleimidoethyl]amine) (TMEA), (3-[(2-aminoethyl)dithio]propionic acid) (AEDP), 4-[p-azidosalicylamido]butylamine, succinimidyl 6-(3-[2-pyridyldithio]-propionamido)hexanoate (LC-SPDP), sulfo-NHS diazirine (sulfo-SDA), LC-SMCC, SPDP, Sulfo-EMCS, Sulfo-GMBS, GMBS, Sulfo-KMUS, Sulfo-LC-SMPT, SMPT, Sulfo-MBS, MBS, Sulfo-SIAB, SIAB, Sulfo-SMPB, SMPB, AMAS, APDP, BMPS, EMCA, KMUA, SBAP, STA, SMPH, carboiimides such as 1-ethyl-3-(3-dimethylaminopropyl)carbodiimide hydrochloride, and 1-cyclohexyl-3-(2-morpholinyl-4-ethyl)carbodiimide sulfonate, 1,3-di-p-tolylcarbodiimide; 1,3-diisopropylcarbodiimide, 1,3-dicyclohexylcarbodiimide, 1-cyclohexyl-3-(2-morpholinoethyl)carbodiimide metho-p-toluenesulfonate, polycarbodiimide, 1-tert-butyl-3-ethylcarbodiimide, 1,3-dicyclohexylcarbodiimide; 1,3-bis(trimethylsilyl)carbodiimide, 1,3-di-tert-butylcarbodiimide, 1-(3-dimethylaminopropyl)-3-ethylcarbodiimide methiodide, 1-(3-dimethylaminopropyl)-3-ethylcarbodiimide, and 1-[3-(dimethylamino)propyl]-3-ethylcarbodiimide methiodide, and aldehydes such as glyoxal, glutaraldehyde, adipaldehyde, succinaldehyde, and suberaldehyde. Additional protein cross-linkers are commercially available from Pierce Biotechnology, (Rockford, Ill.), Molecular Probes (Eugene, Oreg.), and Sigma-Aldrich (St. Louis, Mo.).

Cytokine: A generic name for a diverse group of soluble proteins and peptides that act as humoral regulators at nano- to picomolar concentrations and which, either under normal or pathological conditions, modulate the functional activities of individual cells and tissues. These proteins also mediate interactions between cells directly and regulate processes taking place in the extracellular environment. Cytokines include both naturally occurring peptides and variants that retain full or partial biological activity. Cytokines bind to cytokine receptors and thus are cytokine receptor ligands.

Examples of cytokines include interleukins, such as IL-1α, IL-1βIL-2, IL-3, IL-4, IL-5, IL-6, IL-7, IL-8, IL-10 and IL-12; interferons, such as IFN-α, IFN-β and IFN-γ; tumor necrosis factors, such as TNF-α and TNF-β macrophage; inflammatory proteins, such as MIP-1α and MIP-1β; and transforming growth factors, such as TGF-β. In some embodiments, a cytokine or portion thereof is part of a disclosed functionalized electrode. In some embodiments, an antibody that specifically binds a cytokine or portion thereof is part of a disclosed functionalized electrode, thus the presence of a cytokine in a sample can be determined using a disclosed functionalized electrode.

Cyclic voltammetry: An electrochemical technique that can be used to obtain information about the redox potential of analyte solutions or enzyme substrate pairs, for example to select an enzyme substrate pair for inclusion in a disclosed biosensor. The voltage is swept between two values at a fixed rate, however, when the voltage reaches V2 the scan is reversed and the voltage is swept back to V1. The voltage is measured between a reference electrode and the working electrode, while the current is measured between the working electrode and the counter electrode. The obtained measurements are plotted as current vs. voltage, also known as a voltammogram. As the voltage is increased toward the electrochemical reduction potential of the analyte, the current will also increase. With increasing voltage toward V2 past this reduction potential, the current decreases, having formed a peak, since the oxidation potential has been exceeded. As the voltage is reversed to complete the scan toward V1, the reaction will begin to reoxidize the product from the initial reaction. This produces an increase in current of opposite polarity as compared to the forward scan, but again decreases having formed a second peak as the voltage scan continues toward V1. The reverse scan also provides information about the reversibility of a reaction at a given scan rate. The shape of the voltammogram for a given compound depends not only on the scan rate and the electrode surface, which is different after each adsorption step, but can also depend on the catalyst concentration.

Detect: To determine if an agent (such as a signal or target analyte) is present or absent. In some examples, this can further include quantification. In some examples, an electromagnetic signal is used to detect the presence, amount or concentration of an agent, such as an analyte. In some examples, the detection is indirect, for example using an enzyme that catalyzes the production of a detectable signal when an analyte is present. In other examples, the signal is reduced when the analyte is present, such that increasing concentration of an analyte gives a decrease in signal.

Epitope: An antigenic determinant. These are particular chemical groups or contiguous or non-contiguous peptide sequences on a molecule that are antigenic, that is, that elicit a specific immune response. An antibody binds a particular antigenic epitope based on the three dimensional structure of the antibody and the matching (or cognate) epitope.

Electromagnetic radiation: A series of electromagnetic waves that are propagated by simultaneous periodic variations of electric and magnetic field intensity, and that includes radio waves, infrared, visible light, ultraviolet light, X-rays and gamma rays. In particular examples, electromagnetic is in the form of electrons, which can be detected as a change in current in an electrode, for example the functionalized electrodes disclosed herein.

Fungal pathogen: A fungus that causes disease. Examples of fungal pathogens for use in accordance with the disclosed methods and compositions include without limitation any one or more of (or any combination of) Trichophyton rubrum, T. mentagrophytes, Epidermophyton floccosum, Microsporum canis, Pityrosporum orbiculare (Malassezia furfur), Candida sp. (such as Candida albicans), Aspergillus sp. (such as Aspergillus fumigatus, Aspergillus flavus and Aspergillus clavatus), Cryptococcus sp. (such as Cryptococcus neoformans, Cryptococcus gattii, Cryptococcus laurentii and Cryptococcus albidus), Histoplasma sp. (such as Histoplasma capsulatum), Pneumocystis sp. (such as Pneumocystis jirovecii), and Stachybotrys (such as Stachybotrys chartarum). In some embodiments, a disclosed functionalized electrode includes one or more antigens derived from one or more of the organisms listed above. In some embodiments, an antibody that specifically binds antigens derived from one or more of the organisms listed above is part of a disclosed functionalized electrode, and thus in some examples can be used to detect such antigens in a sample, for example to diagnose a particular fungal infection or the presence of a fungus in an environmental sample.

Growth factor: Proteins capable of stimulating cellular proliferation and cellular differentiation. Examples of growth factors include transforming growth factor beta (TGF-β), granulocyte-colony stimulating factor (G-CSF), granulocyte-macrophage colony stimulating factor (GM-CSF), nerve growth factor (NGF), neurotrophins, platelet-derived growth factor (PDGF), erythropoietin (EPO), thrombopoietin (TPO), myostatin (GDF-8), growth differentiation factor-9 (GDF-9), basic fibroblast growth factor (bFGF or FGF2), epidermal growth factor (EGF), hepatocyte growth factor (HGF) and the like. In some embodiments, a growth factor or portion thereof is part of a disclosed functionalized electrode. In some embodiments, an antibody that specifically binds a growth factor or portion thereof is part of a disclosed functionalized electrode and thus in some examples can be used to detect such growth factors in a sample.

Heterologous: With reference to a molecule, such as a linker, “heterologous” refers to molecules that are not normally associated with each other, for example as a single molecule. Thus, a “heterologous” linker is a linker attached to another molecule that the linker is usually not found in association with in nature, such as in a wild-type molecule.

High throughput technique: Through this process, one can rapidly identify analytes present in a sample or multiple samples. In certain examples, combining modern robotics, data processing and control software, liquid handling devices, and sensitive detectors, high throughput techniques allows the rapid detection and/or quantification of an analyte in a short period of time, for example using the assays and compositions disclosed herein.

Hormone: A classification of small molecules that carries a signal from one cell (or group of cells) to another. Examples of hormones include amine-tryptophans, such as melatonin (n-acetyl-5-methoxytryptamine) and serotonin; amine-tyrosines, such as thyroxine (thyroid hormone), triiodothyronine (thyroid hormone), epinephrine (adrenaline), norepinephrine (noradrenaline) and dopamine; peptide hormones, such as antimullerian hormone (mullerian inhibiting factor), adiponectin, adrenocorticotropic hormone (orticotropin), angiotensinogen and angiotensin, antidiuretic hormone (vasopressin, arginine vasopressin), atrial-natriuretic peptide atriopeptin), calcitonin, cholecystokinin, corticotropin-releasing hormone, erythropoietin, follicle-stimulating hormone, gastrin, ghrelin, glucagon, gonadotropin-releasing hormone, growth hormone-releasing hormone, human chorionic gonadotropin, human placental lactogen, growth hormone, inhibin, insulin, insulin-like growth factor (somatomedin), leptin, luteinizing hormone, melanocyte stimulating hormone, oxytocin, parathyroid hormone, prolactin, relaxin, secretin, somatostatin, thrombopoietin, thyroid-stimulating hormone and thyrotropin-releasing hormone; steroids, such as cortisol, aldosterone, testosterone, dehydroepiandrosterone, androstenedione, dihydrotestosterone, estradiol, estrone, estriol, progesterone and calcitriol (vitamin d3); and eicosanoids, such as prostaglandins, leukotrienes, prostacyclin and thromboxane, among others. In some embodiments, a hormone or portion thereof is part of a disclosed functionalized electrode. In some embodiments, an antibody that specifically binds a hormone or portion thereof is part of disclosed functionalized electrode. Thus in some examples the disclosed functionalized electrodes can be used to detect such hormones.

Isolated: An “isolated” biological component (such as a biomolecule) has been substantially separated or purified away from other components in a mixture.

Ligand: Any molecule which specifically binds an analyte of interest (for example a target analyte), such as an antibody, protein, peptide or a small molecule (for example a molecule with a molecular weight less than 10 kiloDaltons, (kD) that specifically binds an analyte, such as a target analyte).

Linker: A compound or moiety that acts as a molecular bridge to operably link two different molecules, wherein one portion of the linker is operably linked to a first molecule and wherein another portion of the linker is operably linked to a second molecule. In some examples a linker is a polypeptide. The two different molecules can be linked to the linker in a step-wise manner. There is no particular size or content limitations for the linker so long as it can fulfill its purpose as a molecular bridge. Linkers are known to those skilled in the art to include, but are not limited to, chemical chains, chemical compounds, carbohydrate chains, peptides, haptens and the like. The linkers can include, but are not limited to, homobifunctional linkers and heterobifunctional linkers. Heterobifunctional linkers, well known to those skilled in the art, contain one end having a first reactive functionality to specifically link a first molecule and an opposite end having a second reactive functionality to specifically link to a second molecule. Depending on such factors as the molecules to be linked and the conditions in which the method of detection is performed, the linker can vary in length and composition for optimizing such properties as flexibility, stability and resistance to certain chemical and/or temperature parameters.

Nucleic acid: A polymer composed of nucleotide units (ribonucleotides, deoxyribonucleotides, related naturally occurring structural variants and synthetic non-naturally occurring analogs thereof or combinations thereof) linked via phosphodiester bonds, related naturally occurring structural variants and synthetic non-naturally occurring analogs thereof. Thus, the term includes nucleotide polymers in which the nucleotides and the linkages between them include non-naturally occurring synthetic analogs, such as, for example and without limitation, phosphorothiolates, phosphoramidates, methyl phosphonates, chiral-methyl phosphonates, 2-O-methyl ribonucleotides, peptide-nucleic acids (PNAs) and the like. Such polynucleotides can be synthesized, for example, using an automated DNA synthesizer. The term “oligonucleotide” typically refers to short polynucleotides, generally no greater than about 50 nucleotides. It will be understood that when a nucleotide sequence is represented by a DNA sequence (i.e., A, T, G, C), this also includes an RNA sequence (i.e., A, U, G, C) in which “U” replaces “T.”

Conventional notation is used herein to describe nucleotide sequences: the left-hand end of a single-stranded nucleotide sequence is the 5′-end; the left-hand direction of a double-stranded nucleotide sequence is referred to as the 5′-direction. The direction of 5′ to 3′ addition of nucleotides to nascent RNA transcripts is referred to as the transcription direction. The DNA strand having the same sequence as an mRNA is referred to as the “coding strand;” sequences on the DNA strand having the same sequence as an mRNA transcribed from that DNA and which are located 5′ to the 5′-end of the RNA transcript are referred to as “upstream sequences;” sequences on the DNA strand having the same sequence as the RNA and which are 3′ to the 3′ end of the coding RNA transcript are referred to as “downstream sequences.”

“Recombinant nucleic acid” refers to a nucleic acid having nucleotide sequences that are not naturally joined together. This includes nucleic acid vectors comprising an amplified or assembled nucleic acid which can be used to transform a suitable host cell. A host cell that comprises the recombinant nucleic acid is referred to as a “recombinant host cell.” The gene is then expressed in the recombinant host cell to produce, for example a “recombinant polypeptide.” A recombinant nucleic acid may serve a non-coding function (for example a promoter, origin of replication, ribosome-binding site, etc.) as well.

For sequence comparison of nucleic acid sequences, typically one sequence acts as a reference sequence, to which test sequences are compared. When using a sequence comparison algorithm, test and reference sequences are entered into a computer, subsequence coordinates are designated, if necessary and sequence algorithm program parameters are designated. Default program parameters are used. Methods of alignment of sequences for comparison are well known in the art. Optimal alignment of sequences for comparison can be conducted, for example, by the local homology algorithm of Smith & Waterman, Adv. Appl. Math. 2:482, 1981, by the homology alignment algorithm of Needleman & Wunsch, J. Mol. Biol. 48:443, 1970, by the search for similarity method of Pearson & Lipman, Proc. Nat'l. Acad. Sci. USA 85:2444, 1988, by computerized implementations of these algorithms (GAP, BESTFIT, FASTA and TFASTA in the Wisconsin Genetics Software Package, Genetics Computer Group, 575 Science Dr., Madison, Wis.) or by manual alignment and visual inspection (see, for example, Current Protocols in Molecular Biology (Ausubel et al., eds 1995 supplement)).

One example of a useful algorithm is PILEUP. PILEUP uses a simplification of the progressive alignment method of Feng & Doolittle, J. Mol. Evol. 35:351-360, 1987. The method used is similar to the method described by Higgins & Sharp, CABIOS 5:151-153, 1989. Using PILEUP, a reference sequence is compared to other test sequences to determine the percent sequence identity relationship using the following parameters: default gap weight (3.00), default gap length weight (0.10) and weighted end gaps. PILEUP can be obtained from the GCG sequence analysis software package, for example, version 7.0 (Devereaux et al., Nuc. Acids Res. 12:387-395, 1984).

Another example of algorithms that are suitable for determining percent sequence identity and sequence similarity are the BLAST and the BLAST 2.0 algorithm, which are described in Altschul et al., J. Mol. Biol. 215:403-410, 1990 and Altschul et al., Nucleic Acids Res. 25:3389-3402, 1977. Software for performing BLAST analyses is publicly available through the National Center for Biotechnology Information (World Wide Web address ncbi.nlm.nih.gov/). The BLASTN program (for nucleotide sequences) uses as defaults a word length (W) of 11, alignments (B) of 50, expectation (E) of 10, M=5, N=−4 and a comparison of both strands. The BLASTP program uses as defaults a word length (W) of 3 and expectation (E) of 10 and the BLOSUM62 scoring matrix (see Henikoff & Henikoff, Proc. Natl. Acad. Sci. USA 89:10915, 1989).

Nucleotide: The fundamental unit of nucleic acid molecules. A nucleotide includes a nitrogen-containing base attached to a pentose monosaccharide with one, two or three phosphate groups attached by ester linkages to the saccharide moiety.

The major nucleotides of DNA are deoxyadenosine 5′-triphosphate (dATP or A), deoxyguanosine 5′-triphosphate (dGTP or G), deoxycytidine 5′-triphosphate (dCTP or C) and deoxythymidine 5′-triphosphate (dTTP or T). The major nucleotides of RNA are adenosine 5′-triphosphate (ATP or A), guanosine 5′-triphosphate (GTP or G), cytidine 5′-triphosphate (CTP or C) and uridine 5′-triphosphate (UTP or U).

Nucleotides include those nucleotides containing modified bases, modified sugar moieties and modified phosphate backbones, for example as described in U.S. Pat. No. 5,866,336 to Nazarenko et al.

Examples of modified base moieties which can be used to modify nucleotides at any position on its structure include, but are not limited to: 5-fluorouracil, 5-bromouracil, 5-chlorouracil, 5-iodouracil, hypoxanthine, xanthine, acetylcytosine, 5-(carboxyhydroxylmethyl)uracil, 5-carboxymethylaminomethyl-2-thiouridine, 5-carboxymethylaminomethyluracil, dihydrouracil, beta-D-galactosylqueosine, inosine, N˜6-sopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid, 5-methyl-2-thiouracil, 3-(3-amino-3-N-2-carboxypropyl)uracil and 2,6-diaminopurine 2′-deoxyguanosine amongst others.

Examples of modified sugar moieties, which may be used to modify nucleotides at any position on its structure, include, but are not limited to arabinose, 2-fluoroarabinose, xylose and hexose or a modified component of the phosphate backbone, such as phosphorothioate, a phosphorodithioate, a phosphoramidothioate, a phosphoramidate, a phosphordiamidate, a methylphosphonate or an alkyl phosphotriester or analog thereof.

Neuropeptide: Peptides released by neurons in the mammalian brain that specifically bind a neuropeptide receptor. Examples of neuropeptides include α-melanocyte-stimulating hormone (α-MSH), galanin-like peptide, acocaine-and-amphetamine-regulated transcript (CART), neuropeptide Y, agouti-related peptide (AGRP), β-endorphin, dynorphin, enkephalin, galanin, ghrelin, growth-hormone releasing hormone, neurotensin, neuromedin U, somatostatin, galanin, enkephalin cholecystokinin, vasoactive intestinal polypeptide (VIP) and substance P among others. In some embodiments, a neuropeptide or portion thereof is part of a disclosed functionalized electrode. In some embodiments, an antibody that specifically binds a neuropeptide or portion thereof is part of a functionalize electrode, and thus in some examples can be used to detect such peptides in a sample.

Oligonucleotide: A linear polynucleotide sequence of up to about 100 nucleotide bases in length.

Parasite: An organism that lives inside humans or other organisms acting as hosts (for the parasite). Parasites are dependent on their hosts for at least part of their life cycle. Parasites are harmful to humans because they consume needed food, eat away body tissues and cells, and eliminate toxic waste, which makes people sick. Examples of parasites for use in accordance with the disclosed methods and compositions include without limitation any one or more of (or any combination of) Malaria (Plasmodium falciparum, P. vivax, P. malariae), Schistosomes, Trypanosomes, Leishmania, Filarial nematodes, Trichomoniasis, Sarcosporidiasis, Taenia (T. saginata, T. solium), Leishmania, Toxoplasma gondii, Trichinelosis (Trichinella spiralis) or Coccidiosis (Eimeria species). Thus is some embodiments, a disclosed functionalized electrode includes one or more antigens derived from one or more of the organisms listed above. In some embodiments, an antibody that specifically binds antigens derived from one or more of the organisms listed above is part of a disclosed functionalized electrode. Thus in some examples a disclosed functionalized electrode can be used to detect such parasites in a sample, for example to diagnose a particular parasitic infection or the presence of parasites in an environmental sample.

Polypeptide: A polymer in which the monomers are amino acid residues which are joined together through amide bonds. When the amino acids are α-amino acids, either the L-optical isomer or the D-optical isomer can be used. The terms “polypeptide” or “protein” as used herein are intended to encompass any amino acid sequence and include modified sequences such as glycoproteins. “Polypeptide” covers naturally occurring proteins, as well as those which are recombinantly or synthetically produced. “Residue” or “amino acid residue” includes an amino acid that is incorporated into a protein, polypeptide, or peptide.

Purified: The term “purified” does not require absolute purity; rather, it is intended as a relative term. Thus, for example, a purified peptide, protein, conjugate, or other compound is one that is isolated in whole or in part from proteins or other constituents of a mixture. Generally, substantially purified peptides, proteins, conjugates, or other active compounds for use within the disclosure comprise more than 80% of all macromolecular species present in a preparation prior to admixture or formulation of the peptide, protein, conjugate or other active compound with a pharmaceutical carrier, excipient, buffer, absorption enhancing agent, stabilizer, preservative, adjuvant or other co-ingredient. More typically, the peptide, protein, conjugate or other active compound is purified to represent greater than 90%, often greater than 95% of all macromolecular species present in a purified preparation prior to admixture with other formulation ingredients. In other cases, the purified preparation may be essentially homogeneous, wherein other macromolecular species are not detectable by conventional techniques.

Quantitating: Determining or measuring a quantity (such as a relative quantity) of a molecule or the activity of a molecule, such as the quantity of analyte, such as a target analyte present in a sample.

Sample: A material to be analyzed. In one embodiment, a sample is a biological sample. In another embodiment, a sample is an environmental sample, such as soil, sediment water, or air. Environmental samples can be obtained from an industrial source, such as a farm, waste stream, or water source. A biological sample is one that includes biological materials (such as nucleic acid and proteins). In some examples, a biological sample is obtained from an organism or a part thereof, such as an animal. In particular embodiments, the biological sample is obtained from an animal subject, such as a human subject. A biological sample can be any solid or fluid sample obtained from, excreted by or secreted by any living organism, including without limitation multicellular organisms (such as animals, including samples from a healthy or apparently healthy human subject or a human patient affected by a condition or disease to be diagnosed or investigated, such as cancer). For example, a biological sample can be a biological fluid obtained from, for example, blood, plasma, serum, urine, bile, ascites, saliva, cerebrospinal fluid, aqueous or vitreous humor, or any bodily secretion, a transudate, an exudate (for example, fluid obtained from an abscess or any other site of infection or inflammation), or fluid obtained from a joint (for example, a normal joint or a joint affected by disease, such as a rheumatoid arthritis, osteoarthritis, gout or septic arthritis). A biological sample can also be a sample obtained from any organ or tissue (including a biopsy or autopsy specimen, such as a tumor biopsy) or can include a cell (whether a primary cell or cultured cell) or medium conditioned by any cell, tissue or organ. In some examples, a biological sample is a cell lysate, for example a cell lysate obtained from a tumor of a subject.

Specific binding agent: An agent that binds substantially only to a defined target. Thus, an antigen binding agent, such as an antibody that is specific for an antigen is an agent that binds substantially to a specific antigen or fragment thereof. In some examples, the specific binding agent is a monoclonal or polyclonal antibody that specifically binds a specific antigen or antigenic fragment thereof, such as a target analyte. In other examples, the specific binding agent is an antigen that specifically binds to an antibody specific for the antigen. In some examples, a specific binding agent is conjugated to an enzyme, such as an enzyme that catalyzes the reaction of an enzyme substrate into an electroactive product.

Subject: Includes both human and veterinary subjects, for example, humans, non-human primates, dogs, cats, horses, and cows.

Substrate: A molecule that is acted upon by an enzyme. A substrate binds with the enzyme's active site, and an enzyme-substrate complex is formed. In some examples an enzyme substrate is converted to an electroactive product by an enzyme.

Thiol: An organosulfur compound that contains a sulfur-hydrogen bond (S—H). Thiols are the sulfur analogue of an alcohol. The SH functional group can be referred to as either a thiol group or a sulfhydryl group. Thiols have the general chemical formula R—S—H. In some examples, the S—H group can react with and thereby bond to a surface, such as an electrically conductive surface.

Tumor antigen: A tumor antigen is an antigen produced by tumor cells that can stimulate tumor-specific T-cell immune responses. Exemplary tumor antigens include, but are not limited to, RAGE-1, tyrosinase, MAGE-1, MAGE-2, NY-ESO-1, Melan-A/MART-1, glycoprotein (gp) 75, gp100, beta-catenin, preferentially expressed antigen of melanoma (PRAME), MUM-1, Wilms tumor (WT)-1, carcinoembryonic antigen (CEA), and PR-1. Additional tumor antigens are known in the art (for example see Novellino et al., Cancer Immunol. Immunother. 54(3):187-207, 2005) and are described below. Tumor antigens are also referred to as “cancer antigens.” The tumor antigen can be any tumor-associated antigen, which are well known in the art and include, for example, carcinoembryonic antigen (CEA), β-human chorionic gonadotropin, alphafetoprotein (AFP), lectin-reactive AFP, thyroglobulin, RAGE-1, MN-CA IX, human telomerase reverse transcriptase, RU1, RU2 (AS), intestinal carboxyl esterase, mut hsp70-2, macrophage colony stimulating factor, prostase, prostate-specific antigen (PSA), PAP, NY-ESO-1, LAGE-1a, p53, prostein, PSMA, Her2/neu, survivin and telomerase, prostate-carcinoma tumor antigen-1, MAGE, ELF2M, neutrophil elastase, ephrinB2, CD22, insulin growth factor (IGF)-I, IGF-II, IGF-I receptor and mesothelin. A list of selected tumor antigens and their associated tumors are shown below in Table 1.

TABLE 1
Exemplary tumors and their tumor antigens

| Tumor | Tumor Associated Target Antigens |
|---|---|
| Acute myelogenous leukemia | Wilms tumor 1 (WT1), PRAME, PR1, |
| | proteinase 3, elastase, cathepsin G |
| Chronic myelogenous | WT1, PRAME, PR1, proteinase 3, |
| leukemia | elastase, cathepsin G |
| Myelodysplastic syndrome | WT1, PRAME, PR1, proteinase 3, |
| | elastase, cathepsin G |
| Acute lymphoblastic | PRAME |
| leukemia | |
| Chronic lymphocytic | Survivin |
| leukemia | |
| Non-Hodgkin's lymphoma | Survivin |
| Multiple myeloma | NY-ESO-1 |
| Malignant melanoma | MAGE, MART, Tyrosinase, PRAME |
| | GP100 |
| Breast cancer | WT1, Herceptin, epithelial tumor |
| | antigen (ETA) |
| Lung cancer | WT1 |
| Ovarian cancer | CA-125 |
| Prostate cancer | PSA |
| Pancreatic cancer | CA19-9, RCAS1 |
| Colon cancer | CEA |
| Cervical Cancer | SCC, CA125, CEA, Cytokeratins |
| | (TPA, TPS, Cyfra21-1) |
| Renal cell carcinoma (RCC) | Fibroblast growth factor 5 |
| Germ cell tumors | AFP |

In some embodiments, a tumor antigen or portion thereof is part of a disclosed functionalized electrode. In some embodiments, an antibody that specifically binds a tumor antigen or portion thereof is part of a functionalized electrode. Thus in some examples the disclosed functionalized electrodes can be used to detect such antigens in a sample, for example to diagnose a cancer.

Virus: A microscopic infectious organism that reproduces inside living cells. A virus consists essentially of a core of nucleic acid surrounded by a protein coat, and has the ability to replicate only inside a living cell. “Viral replication” is the production of additional virus by the occurrence of at least one viral life cycle. A virus may subvert the host cells' normal functions, causing the cell to behave in a manner determined by the virus. For example, a viral infection may result in a cell producing a cytokine, or responding to a cytokine, when the uninfected cell does not normally do so. In some examples, a virus is a pathogen.

Specific examples of viral pathogens for use in accordance with the disclosed methods and compositions include without limitation any one or more of (or any combination of); Arenaviruses (such as Guanarito virus, Lassa virus, Junin virus, Machupo virus and Sabia), Arteriviruses, Roniviruses, Astroviruses, Bunyaviruses (such as Crimean-Congo hemorrhagic fever virus and Hantavirus), Barnaviruses, Birnaviruses, Bornaviruses (such as Borna disease virus), Bromoviruses, Caliciviruses, Chrysoviruses, Coronaviruses (such as Coronavirus and SARS), Cystoviruses, Closteroviruses, Comoviruses, Dicistroviruses, Flaviruses (such as Yellow fever virus, West Nile virus, Hepatitis C virus, and Dengue fever virus), Filoviruses (such as Ebola virus and Marburg virus), Flexiviruses, Hepeviruses (such as Hepatitis E virus), human adenoviruses (such as human adenovirus A-F), human astroviruses, human BK polyomaviruses, human bocaviruses, human coronavirus (such as a human coronavirus HKU1, NL63, and OC43), human enteroviruses (such as human enterovirus A-D), human erythrovirus V9, human foamy viruses, human herpesviruses (such as human herpesvirus 1 (herpes simplex virus type 1), human herpesvirus 2 (herpes simplex virus type 2), human herpesvirus 3 (Varicella zoster virus), human herpesvirus 4 type 1 (Epstein-Barr virus type 1), human herpesvirus 4 type 2 (Epstein-Barr virus type 2), human herpesvirus 5 strain AD169, human herpesvirus 5 strain Merlin Strain, human herpesvirus 6A, human herpesvirus 6B, human herpesvirus 7, human herpesvirus 8 type M, human herpesvirus 8 type P and Human Cyotmegalovirus), human immunodeficiency viruses (HIV) (such as HIV 1 and HIV 2), human metapneumoviruses, human papillomaviruses, human parainfluenza viruses (such as human parainfluenza virus 1-3), human parechoviruses, human parvoviruses (such as human parvovirus 4 and human parvovirus B19), human respiratory syncytial viruses, human rhinoviruses (such as human rhinovirus A and human rhinovirus B), human spumaretroviruses, human T-lymphotropic viruses (such as human T-lymphotropic virus 1 and human T-lymphotropic virus 2), Human polyoma viruses, Hypoviruses, Leviviruses, Luteoviruses, Lymphocytic choriomeningitis viruses (LCM), Marnaviruses, Narnaviruses, Nidovirales, Nodaviruses, Orthomyxoviruses (such as Influenza viruses), Partitiviruses, Paramyxoviruses (such as Measles virus and Mumps virus), Picornaviruses (such as Poliovirus, the common cold virus, and Hepatitis A virus), Potyviruses, Poxviruses (such as Variola and Cowpox), Sequiviruses, Reoviruses (such as Rotavirus), Rhabdoviruses (such as Rabies virus), Rhabdoviruses (such as Vesicular stomatitis virus, Tetraviruses, Togaviruses (such as Rubella virus and Ross River virus), Tombusviruses, Totiviruses, Tymoviruses, and Noroviruses among others.

Viral antigens may be from a Hepatitis C virus (HCV). HCV antigens may be selected from one or more of E1, E2, E1/E2, NS345 polyprotein, NS 345-core polyprotein, core, and/or peptides from the nonstructural regions (Houghton et al. (1991) Hepatology 14:381-388, which is incorporated by reference).

Viral antigens may be derived from a Human Herpes virus, such as Herpes Simplex Virus (HSV), Varicella-zoster virus (VZV), Epstein-Barr virus (EBV), or Cytomegalovirus (CMV). Human Herpes virus antigens may be selected from immediate early proteins, early proteins, and late proteins. HSV antigens may be derived from HSV-I or HSV-2 strains. HSV antigens may be selected from glycoproteins gB, gC, gD and gH, or immune escape proteins (gC, gE, or gl). VZV antigens may be selected from core, nucleocapsid, tegument, or envelope proteins. A live attenuated VZV vaccine is commercially available. EBV antigens may be selected from early antigen (EA) proteins, viral capsid antigen (VCA), and glycoproteins of the membrane antigen (MA). CMV antigens may be selected from capsid proteins, envelope glycoproteins (such as gB and gH), and tegument proteins. Exemplary herpes antigens include (GENBANK™ Accession No. in parentheses) those derived from human herpesvirus 1 (Herpes simplex virus type 1) (NC_{—}001806), human herpesvirus 2 (Herpes simplex virus type 2) (NC_{—}001798), human herpesvirus 3 (Varicella zoster virus) (NC_{—}001348), human herpesvirus 4 type 1 (Epstein-Barr virus type 1) (NC_{—}007605), human herpesvirus 4 type 2 (Epstein-Ban virus type 2) (NC_{—}009334), human herpesvirus 5 strain AD169 (NC_{—}001347), human herpesvirus 5 strain Merlin Strain (NC_{—}006273), human herpesvirus 6A (NC_{—}001664), human herpesvirus 6B (NC_{—}000898), human herpesvirus 7 (NC_{—}001716), human herpesvirus 8 type M (NC_{—}003409), and human herpesvirus 8 type P (NC_{—}009333).

Human Papilloma virus (HPV) antigens are known in the art and can be found for example in International Patent Publication No. WO96/19496, (incorporated by reference in its entirety) which discloses variants of HPV E6 and E7 proteins, particularly fusion proteins of E6/E7 with a deletion in both the E6 and E7 proteins. HPV L1 based antigens are disclosed in international Patent publication Nos. WO94/00152, WO94/20137, WO93/02184 and WO94/05792, all of which are incorporated by reference. Such an antigen can include the L1 antigen as a monomer, a capsomer or a virus like particle. Such particles may additionally comprise L2 proteins. Other HPV antigens are the early proteins, such as E7 or fusion proteins such as L2-E7. Exemplary HPV antigens include (GENBANK™ Accession No. in parentheses) those derived from human papillomavirus-1 (NC_{—}001356), human papillomavirus-18 (NC_{—}001357), human papillomavirus-2 (NC_{—}001352), human papillomavirus-54 (NC_{—}001676), human papillomavirus-61 (NC_{—}001694), human papillomavirus-cand90 (NC_{—}004104), human papillomavirus RTRX7 (NC_{—}004761), human papillomavirus type 10 (NC_{—}001576), human papillomavirus type 101 (NC_{—}008189), human papillomavirus type 103 (NC_{—}008188), human papillomavirus type 107 (NC_{—}009239), human papillomavirus type 16 (NC_{—}001526), human papillomavirus type 24 (NC_{—}001683), human papillomavirus type 26 (NC_{—}001583), human papillomavirus type 32 (NC_{—}001586), human papillomavirus type 34 (NC_{—}001587), human papillomavirus type 4 (NC_{—}001457), human papillomavirus type 41 (NC_{—}001354), human papillomavirus type 48 (NC_{—}001690), human papillomavirus type 49 (NC_{—}001591), human papillomavirus type 5 (NC_{—}001531), human papillomavirus type 50 (NC_{—}001691), human papillomavirus type 53 (NC_{—}001593), human papillomavirus type 60 (NC_{—}001693), human papillomavirus type 63 (NC_{—}001458), human papillomavirus type 6b (NC_{—}001355), human papillomavirus type 7 (NC_{—}001595), human papillomavirus type 71 (NC_{—}002644), human papillomavirus type 9 (NC_{—}001596), human papillomavirus type 92 (NC_{—}004500), and human papillomavirus type 96 (NC_{—}005134).

Viral antigens may be derived from a Retrovirus, such as an Oncovirus, a Lentivirus or a Spumavirus. Oncovirus antigens may be derived from HTLV-I, HTLV-2 or HTLV-5. Lentivirus antigens may be derived from HIV-I or HIV-2. Retrovirus antigens may be selected from gag, pol, env, tax, tat, rex, rev, nef, vif, vpu, and vpr. Antigens for HIV are known in the art, for example HIV antigens may be selected from gag (p24gag and p55gag), env (gp160 and gp41), pol, tat, nef, rev vpu, miniproteins, (p55 gag and gp140v). HIV antigens may be derived from one or more of the following strains: HIVmb, HIV; HIVLAV, HIVLAI, HIVM N, HIV-1 CM235, HIV-1 US4. Examples of HIV antigens can be found in International Patent Publication Nos. WO09/089,568, WO09/080,719, WO08/099,284, and WO00/15255, and U.S. Pat. Nos. 7,531,181 and 6,225,443, all of which are incorporated by reference. Exemplary HIV antigens include (GENBANK™ Accession No. in parentheses) those derived from human immunodeficiency virus 1 (NC_{—}001802), human immunodeficiency virus 2 (NC_{—}001722).

In some embodiments, a disclosed functionalized electrode includes one or more antigens derived from one or more of the viruses listed above. In some embodiments, an antibody that specifically binds antigens derived from one or more of the viruses listed above is part of a functionalized electrode. Thus in some examples the disclosed functionalized electrodes can be used to detect such viruses in a sample, for example to diagnose a viral infection or the presence of a virus in an environmental sample.

### II. Overview of Several Embodiments

The general performance of electrochemical sensors is often determined by the surface architectures that connect the sensing element to the biological sample at the nanometer scale. Electrochemical biosensors have suffered from a lack of surface architectures allowing high enough sensitivity and unique identification of the response with the desired biochemical event.

Various prior attempts have been made to fashion biosensors out of long chain self-assembled monolayers (SAMs) because of the desirable characteristics of self-assembled monolayers, such as stability and resistance to non-specific biomolecule adsorption. However, electrochemical sensors based on long chain alkyls have suffered from limited applicability because of their low permeability to electron transfer (see e.g. Fragoso et al., Anal. Chem., 80:2556-2563, 2008). In an attempt to overcome the perceived limitations present in long chain SAMs, Fragoso et al. turned to dithiols, which are believed to be less insulating. However, one of the advantages of using long chain SAMs is lost by turning to a less insulating monolayer, namely the loss of selectivity against non-specific electron transfer, which reduces the signal to noise of the sensor and therefore the sensitivity.

Another drawback to the use of SAMs is that they are ionic insulators, that is ions are not readily able to penetrate SAM in order to transfer electrons to and from the underlying electroconductive material of an electrochemical sensor (see e.g. Boubour and Lennox, Langmuir 16:4222-4228, 2000). While the insulating properties of SAMs are desirable from the stand point of limiting non-specific electron transfer, in the absence of selective ionic transfer for an analyte of interest, SAMs have limited use as components of electrochemical sensors.

As disclosed herein, the limitations present in previous attempts to create sensors from long chain thiol containing SAMs have been overcome by careful selection of thiol compounds that retain their insulating properties toward non-specific electron transfer coupled with the selection of enzyme reaction products that are electroactive and capable of facilitating electron transfer through the monolayer to the electron conducting surface. Thus, disclosed herein it has been surprisingly found that functionalized electrodes can be formed that retain the beneficial insulating properties on SAMs such as to yield high signal to noise, in conjunction with high selectivity and sensitivity.

Thus, disclosed herein are functionalized electrodes. In some embodiments, a functionalized electrode includes an electrically conducting surface, a first thiol compound and a second thiol compound. In one example, the first thiol compound has the formula HS—(CH₂)x-(OCH₂CH₂)y-NH₂, or a salt there of, such as a chloride salt, wherein x is an integer ranging from 1-30 and y is an integer ranging from 0-10, and wherein the first thiol compound is bound to the electrically conducting surface through the reaction of the sulfhydryl moiety in the first thiol compound and the electrically conducting surface and wherein the first thiol is covalently linked to a ligand that specifically binds to a target analyte. Further, in some examples, a second thiol compound has the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group and wherein the second thiol compound is bound to the electrical conducting surface through the reaction of the sulfhydryl moiety present in the second thiol compound and the electrically conducting surface. In some examples, the functionalized electrode includes a first thiol compound and a second thiol compound present on the electrically conducting surface in a ratio of 0.01:99.99 to 99.99:0.01.

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

In some embodiments, the functionalized electrode has an electrically conducting surface including a metal surface, such as a transition metal (e.g., gold).

In some embodiments, the functionalized electrode includes a ligand in which the ligand is an antibody, a protein, a peptide, a nucleic acid molecule, or a small molecule that specifically binds a target analyte. In some particular embodiments, the target analyte includes an antibody, a protein, a peptide, a nucleic acid molecule, or a small molecule. In some embodiments, the first thiol is covalently linked to a ligand that specifically binds to a target analyte via the reaction product of Sulfosuccinimidyl-4-(N-maleimidomethyl)cyclohexane-1-carboxylate (Sulfo-SMCC) or sulfo-NHS diazirine (sulfo-SDA).

Also provided herein are biosensors. In one embodiment, a biosensor includes a disclosed functionalized electrode.

Also disclosed herein are biosensor arrays. In one embodiment, a biosensor array includes a plurality of disclosed biosensors.

Additionally, kits are disclosed. In some embodiments, a kit includes one or more disclosed functionalized electrodes and additional reagents for the detection of a target analyte.

Systems for detecting a target analyte are also provided herein. In some embodiments, a system for detecting a target analyte includes a first electrode (such as a disclosed functionalized electrode), a second electrode, and an electrochemical instrument capable of applying a controlled potential between the first and second electrode and measuring the current between the two electrodes. In one example, the system includes a second electrode that is a common electrode. In some embodiments, a disclosed system for detecting a target includes a third electrode wherein the second electrode is a counter electrode and the third electrode is a reference electrode. In some embodiments, the electrochemical instrument includes a potentiostat.

Methods of detecting a target analyte in a sample are also provided herein In some embodiments, a method of detecting a target analyte includes the following: contacting a sample with the electrodes of a disclosed system, that includes a disclosed functionalized electrode that is specific for the target analyte, wherein the functionalized electrode includes a ligand that specifically binds to the target analyte (optionally washing the electrodes, for example to remove portions of the sample that are not specifically bound to the functionalized electrode); contacting the electrodes with a detection reagent, wherein the detection reagent includes a specific binding agent that specifically binds to the target analyte wherein the specific binding agent is not identical to the ligand that specifically binds to the target analyte and wherein the detection reagent includes an enzyme that catalyzes a reaction with a substrate to produce an electroactive product; contacting the electrodes with the substrate (optionally washing the electrodes); and measuring the current between the electrodes, wherein detection of a change in current between the electrodes detects the target analyte in the sample. The steps described above can be carried out in any order or simultaneously.

In other embodiments, a method of detecting a target analyte in a sample includes the following: contacting a sample with the electrodes of a disclosed system, wherein the electrodes include a functionalized electrode the includes a ligand that specifically binds to the target analyte (optionally washing the electrodes); contacting the electrodes with a detection reagent, wherein the detection reagent includes a specific binding agent that specifically binds to ligand that specifically binds to the target analyte and wherein the detection reagent includes an enzyme that catalyzes a reaction with a substrate to produce an electroactive product (optionally washing the electrodes); contacting the electrodes with the substrate (optionally washing the electrodes); and measuring the current between the electrodes, wherein detection of a change in current between the electrodes detects the target analyte in the sample. The above steps can be carried out in any order or simultaneously.

In some examples, the method of detecting a target analyte further includes applying a controlled potential across the electrodes. In even further examples, the method of detecting a target analyte further includes quantitating the target analyte in the sample. In some examples, the enzyme is horseradish peroxidase and the substrate is a 1:1 3,3′,5,5′-tetramethylbenzidine (TMB)/H₂O₂ solution.

Also disclosed are methods of making a functionalized electrode for detecting a target analyte. In some embodiments, a method of making a functionalized electrode includes the following: contacting an electrically conducting surface with a mixture including a first thiol compound having the formula HS—(CH₂)x-(OCH₂CH₂)y-NH₂, or a salt there of, such as a chloride salt, wherein x is an integer ranging from 1-30 and y is an integer ranging from 0-10 and a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group, wherein sulfhydryl groups on the first and second thiol compounds bond with the electrically conducting surface, thereby creating a monolayer on the surface of the electrically conducting surface; contacting the monolayer on the surface of the electrically conducting surface with sulfo-NHS diazirine (sulfo-SDA), wherein the sulfo-SDA and the NH₂ chemically react to form a covalent bond; contacting the monolayer on the surface of the electrically conducting surface with a ligand that specifically binds a target analyte, and exposing the monolayer on the surface of the electrically conducting surface to ultra violet radiation; thereby making a functionalized electrode for detecting an target analyte. In some embodiments, the first thiol compound and the second thiol compound are present on the electrically conducting surface in a ratio of 0.01:99.99 to 99.99:0.01. In some examples, the electrically conducting surface includes a metal surface, such as a transition metal (e.g., gold). In some examples, the ligand includes an antibody, a protein, a peptide, a nucleic acid molecule, or a small molecule that specifically binds a target analyte. In some examples, the target analyte includes an antibody, a protein, a peptide, a nucleic acid molecule, or a small molecule.

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

A. Functionalized Electrodes

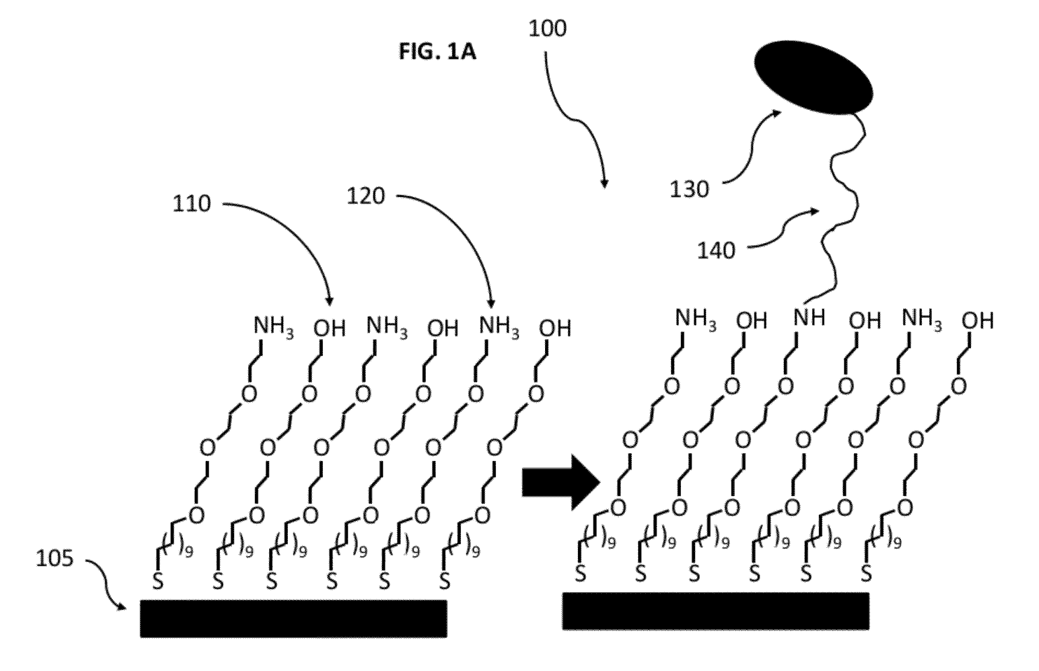

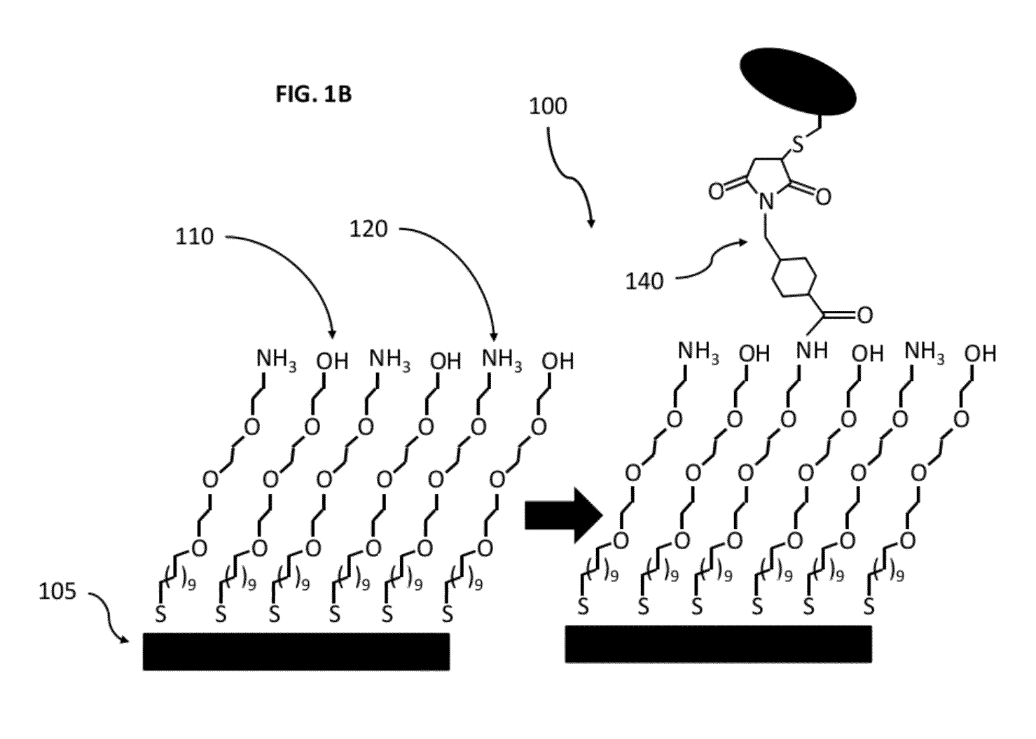

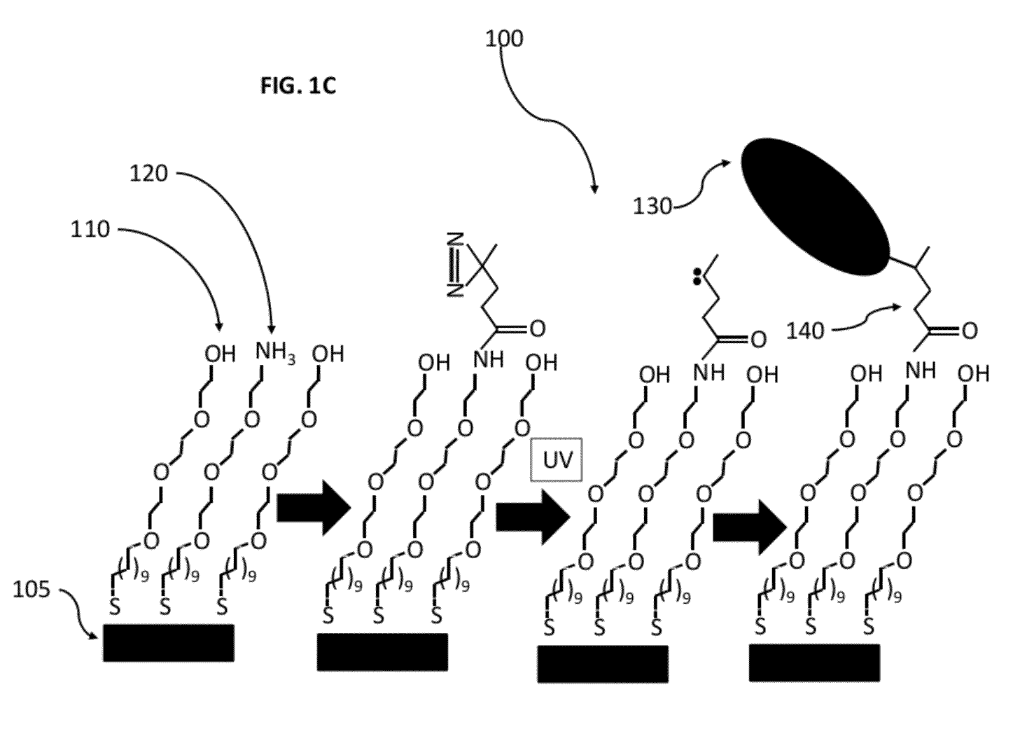

Disclosed herein are functionalized electrodes that have been functionalized such that they can be used to specifically detect a target analyte in a sample, such as a biological sample. Exemplary functionalized electrodes are shown in FIGS. 1A-1C. With reference to FIG. 1A, functional electrode 100 includes electrically conducting surface 105 with bound thiol compounds 110 and 120. At least one of thiol compounds 110 or 120 is linked to ligand 130, through linker 140. FIG. 1B a specific example of a functionalized electrode is shown in the reaction product of sulfosuccinimidyl-4-(N-maleimidomethyl)cyclohexane-1-carboxylate (Sulfo-SMCC) is shown as linker 140. With reference to FIG. 1B, working electrode 100 includes metal surface 105 with bound thiol compounds 110 and 120. At least one of the thiol compounds 110 or 120 is linked to ligand 130, through linker 140. Linker 140 shown is composed of the reaction product of Sulfo-SDA and thiol compound 110 or 120 and ligand 130. FIG. 1C is a specific example of a functionalized electrode is shown in the reaction product of sulfo-NHS diazirine (sulfo-SDA) is shown as linker 140. With reference to FIG. 1C, working electrode 100 includes metal surface 105 with bound thiol compounds 110 and 120. At least one of the thiol compounds 110 or 120 is linked to ligand 130, through linker 140. Linker 140 is composed of the reaction product of Sulfo-SDA and thiol compound 110 or 120 and ligand 130.

While electrically conducting surface 100 is shown as a flat surface in FIGS. 1A-1C, it is envisioned that the surface can be any shape, for example convex, concave, flat, round, molded into a rod, or a tube or even deposited on an underlying surface, for example to give the electrically conducting surface any shape that is desired.

In some embodiments, the electrically conducting surface includes a transition metal, such as scandium, titanium, vanadium, chromium, manganese, iron, cobalt, nickel, copper, zinc, yttrium, zirconium, niobiumm, molybdenum, technetium, ruthenium, rhodium, palladium, silver, cadmium, hafnium, tantalum, tungsten, rhenium, osmium, iridium, platinum, gold, mercury, or combinations thereof, for example alloys, amalgams and/or oxides. In some embodiments, the electrically conducting surface comprises a precious metal, such as gold, silver, or platinum or a combination thereof, such as an alloy or an amalgam or an oxide. In some embodiments, the electrically conducting surface is gold, such as clean gold. In some embodiments, the electrically conducting surface includes other material that can typically be found in electrodes, such as carbon, for example as in a graphite electrode. The requirements for the electrically conducting surface are that it is capable of conducting electricity and that it is capable of forming a bond to a sulfhydryl.

The disclosed functionalized electrodes include a first thiol compound having the formula HS—(CH₂)x-(OCH₂CH₂)y-NH₂, or a salt there of, such as a chloride salt, wherein x is an integer ranging from 1-30 and y is an integer ranging from 0-10, such that the sulfhydryl moiety can form a bond with the electrically conducting surface and the amine moiety (NH₂) can form a bond with a linker.

In some examples the first thiol compound has the chemical formula HS—(CH₂)x-(OCH₂CH₂)y-NH₂, or a salt there of, such as a chloride salt, wherein x is an integer ranging from 1-30 (for example x can 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30, such as 1-2, 1-3, 1-4, 1-5, 1-6, 1-7, 1-8, 1-9, 1-10, 1-11, 1-12, 1-13, 1-14, 1-15, 1-16, 1-17, 1-18, 1-19, 1-20, 1-21, 1-22, 1-23, 1-24, 1-25, 1-26, 1-27, 1-28, 1-29, 1-30, 2-3, 2-4, 2-5, 2-6, 2-7, 2-8, 2-9, 2-10, 2-11, 2-12, 2-13, 2-14, 2-15, 2-16, 2-17, 2-18, 2-19, 2-20, 2-21, 2-22, 2-23, 2-24, 2-25, 2-26, 2-27, 2-28, 2-29, 2-30, 3-4, 3-5, 3-6, 3-7, 3-8, 3-9, 3-10, 3-11, 3-12, 3-13, 3-14, 3-15, 3-16, 3-17, 3-18, 3-19, 3-20, 3-21, 3-22, 3-23, 3-24, 3-25, 3-26, 3-27, 3-28, 3-29, 3-30, 4-5, 4-6, 4-7, 4-8, 4-9, 4-10, 4-11, 4-12, 4-13, 4-14, 4-15, 4-16, 4-17, 4-18, 4-19, 4-20, 4-21, 4-22, 4-23, 4-24, 4-25, 4-26, 4-27, 4-28, 4-29, 4-30, 5-6, 5-7, 5-8, 5-9, 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-7, 6-8, 6-9, 6-10, 6-11, 6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-8, 7-9, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-9, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-19, 10-20, 10-21, 10-22, 10-23, 10-24, 10-25, 10-26, 10-27, 10-28, 10-29, 10-30, 11-12, 11-13, 11-14, 11-15, 11-16, 11-17, 11-18, 11-19, 11-20, 11-21, 11-22, 11-23, 11-24, 11-25, 11-26, 11-27, 11-28, 11-29, 11-30, 12-13, 12-14, 12-15, 12-16, 12-17, 12-18, 12-19, 12-20, 12-21, 12-22, 12-23, 12-24, 12-25, 12-26, 12-27, 12-28, 12-29, 12-30, 13-14, 13-15, 13-16, 13-17, 13-18, 13-19, 13-20, 13-21, 13-22, 13-23, 13-24, 13-25, 13-26, 13-27, 13-28, 13-29, 13-30, 14-15, 14-16, 14-17, 14-18, 14-19, 14-20, 14-21, 14-22, 14-23, 14-24, 14-25, 14-26, 14-27, 14-28, 14-29, 14-30, 15-16, 15-17, 15-18, 15-19, 15-20, 15-21, 15-22, 15-23, 15-24, 15-25, 15-26, 15-27, 15-28, 15-29, 15-30, 16-17, 16-18, 16-19, 16-20, 16-21, 16-22, 16-23, 16-24, 16-25, 16-26, 16-27, 16-28, 16-29, 16-30, 17-18, 17-19, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30 20-21, 10-22, 20-23, 20-24, 20-25, 20-26, 20-27, 20-28, 20-29, 20-30, 21-22, 11-23, 21-24, 21-25, 21-26, 21-27, 21-28, 21-29, 21-30, 22-23, 22-24, 22-25, 22-26, 22-27, 22-28, 22-29, 22-30, 23-24, 23-25, 23-26, 23-27, 23-28, 23-29, 23-30 24-25, 24-26, 24-27, 24-28, 24-29, 24-30, 25-26, 25-27, 25-28, 25-29, 25-30, 26-27, 26-28, 26-29, 26-30, 28-29, 28-30, or 29 30) and y is an integer ranging from 0-10 (for example y can be 1, 2, 3, 4, 5, 6, 7, 8, 9, 10, such as for example x can be 1-2, 1-3, 1-4, 1-5, 1-6, 1-7, 1-8, 1-9, 1-10, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, or 9-10).

The disclosed functionalized electrodes include a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group, such that the sulfhydryl moiety can form a bond with the electrically conducting surface.

In some examples, the second thiol compound has the chemical formula HS—(CH₂)n-(OCH₂CH₂)m-R, wherein n is an integer ranging from 1-30 (for example n can 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30, such as 1-2, 1-3, 1-4, 1-5, 1-6, 1-7, 1-8, 1-9, 1-10, 1-11, 1-12, 1-13, 1-14, 1-15, 1-16, 1-17, 1-18, 1-19, 1-20, 1-21, 1-22, 1-23, 1-24, 1-25, 1-26, 1-27, 1-28, 1-29, 1-30, 2-3, 2-4, 2-5, 2-6, 2-7, 2-8, 2-9, 2-10, 2-11, 2-12, 2-13, 2-14, 2-15, 2-16, 2-17, 2-18, 2-19, 2-20, 2-21, 2-22, 2-23, 2-24, 2-25, 2-26, 2-27, 2-28, 2-29, 2-30, 3-4, 3-5, 3-6, 3-7, 3-8, 3-9, 3-10, 3-11, 3-12, 3-13, 3-14, 3-15, 3-16, 3-17, 3-18, 3-19, 3-20, 3-21, 3-22, 3-23, 3-24, 3-25, 3-26, 3-27, 3-28, 3-29, 3-30, 4-5, 4-6, 4-7, 4-8, 4-9, 4-10, 4-11, 4-12, 4-13, 4-14, 4-15, 4-16, 4-17, 4-18, 4-19, 4-20, 4-21, 4-22, 4-23, 4-24, 4-25, 4-26, 4-27, 4-28, 4-29, 4-30, 5-6, 5-7, 5-8, 5-9, 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-7, 6-8, 6-9, 6-10, 6-11, 6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-8, 7-9, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-9, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-19, 10-20, 10-21, 10-22, 10-23, 10-24, 10-25, 10-26, 10-27, 10-28, 10-29, 10-30, 11-12, 11-13, 11-14, 11-15, 11-16, 11-17, 11-18, 11-19, 11-20, 11-21, 11-22, 11-23, 11-24, 11-25, 11-26, 11-27, 11-28, 11-29, 11-30, 12-13, 12-14, 12-15, 12-16, 12-17, 12-18, 12-19, 12-20, 12-21, 12-22, 12-23, 12-24, 12-25, 12-26, 12-27, 12-28, 12-29, 12-30, 13-14, 13-15, 13-16, 13-17, 13-18, 13-19, 13-20, 13-21, 13-22, 13-23, 13-24, 13-25, 13-26, 13-27, 13-28, 13-29, 13-30, 14-15, 14-16, 14-17, 14-18, 14-19, 14-20, 14-21, 14-22, 14-23, 14-24, 14-25, 14-26, 14-27, 14-28, 14-29, 14-30, 15-16, 15-17, 15-18, 15-19, 15-20, 15-21, 15-22, 15-23, 15-24, 15-25, 15-26, 15-27, 15-28, 15-29, 15-30, 16-17, 16-18, 16-19, 16-20, 16-21, 16-22, 16-23, 16-24, 16-25, 16-26, 16-27, 16-28, 16-29, 16-30, 17-18, 17-19, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30 20-21, 10-22, 20-23, 20-24, 20-25, 20-26, 20-27, 20-28, 20-29, 20-30, 21-22, 11-23, 21-24, 21-25, 21-26, 21-27, 21-28, 21-29, 21-30, 22-23, 22-24, 22-25, 22-26, 22-27, 22-28, 22-29, 22-30, 23-24, 23-25, 23-26, 23-27, 23-28, 23-29, 23-30 24-25, 24-26, 24-27, 24-28, 24-29, 24-30, 25-26, 25-27, 25-28, 25-29, 25-30, 26-27, 26-28, 26-29, 26-30, 28-29, 28-30, or 29 30) and m is an integer ranging from 0-10 (for example m can be 1, 2, 3, 4, 5, 6, 7, 8, 9, 10, such as 1-2, 1-3, 1-4, 1-5, 1-6, 1-7, 1-8, 1-9, 1-10, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, or 9-10).

The first and second thiols can be present on the surface of the electrically conducting surface in any ratio that is dictated by the specific electrical properties that are desired. For example, the ratio of the first thiol compound to the second thiol compound present on the electrically conducting surface can be between about 0.01:99.99 to about 99.99:0.01, such as about 0.01:99.99, about 0.1:99.9, about 1:99, about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, about 99:1, about 99.9:0.1, or about 99.99:0.01.

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

The disclosed functionalized electrodes include molecules, such as ligands, for example agents that specifically bind a target analyte that are linked to the thiol compounds, through the amine moiety on the end of the bound thiol distal to the electrically conducting surface ligands can be linked to the thiol compounds using any number of means known to those of skill in the art. In one example, a ligand that specifically binds a target analyte is covalently bound to a thiol compounds. The linker can be any molecule used to join a molecule to another molecule. Depending on such factors as the molecules to be linked and the conditions in which the method of detection is performed, the linker can vary in length and composition for optimizing such properties as flexibility, stability and resistance to certain chemical and/or temperature parameters.

Suitable linkers are well known to those of skill in the art and include, but are not limited to, straight or branched-chain carbon linkers, heterocyclic carbon linkers or peptide linkers. One skilled in the art will recognize, for a functionalized electrode formed from two or more constituents, each of the constituents will contain the necessary reactive groups. Representative combinations of such groups are amino with carboxyl to form amide linkages or carboxy with hydroxyl to form ester linkages or amino with alkyl halides to form alkylamino linkages or thiols with thiols to form disulfides or thiols with maleimides or alkylhalides to form thioethers. Hydroxyl, carboxyl, amino and other functionalities, where not present may be introduced by known methods. Likewise, as those skilled in the art will recognize, a wide variety of linking groups may be employed. The covalent linkages should be stable relative to the solution conditions under which the functionalized electrode is subjected.

Where the ligands are polypeptides, the linkers may be joined to the constituent amino acids through their side groups (such as through a disulfide linkage to cysteine) or to the alpha carbon amino and carboxyl groups of the terminal amino acids.

The procedure to attach a polypeptide to a monolayer on the surface of an electrically conducting surface varies according to the chemical structure of the molecule. Polypeptides typically contain a variety of functional groups; for example, carboxylic acid (COOH), free amine (—NH₂) or sulfhydryl (—SH) groups, which are available for reaction with a suitable functional group on a polypeptide. Alternatively, the polypeptide is derivatized to expose or attach additional reactive functional groups. The derivatization may involve attachment of any of a number of linker molecules such as those available from Pierce Chemical Company, Rockford, Ill. Examples of representative crosslinkers are given in the forgoing Listing of Terms. In specific embodiments the ligand is linked to the thiol compound by sulfosuccinimidyl-4-(N-maleimidomethyl)cyclohexane-1-carboxylate (Sulfo-SMCC) or sulfo-NHS diazirine (sulfo-SDA).

The functionalized electrodes include a ligand that is specific for an analyte of interest. In some embodiments, the ligand includes an antibody, a peptide, a nucleic acid molecule, or a small molecule that specifically binds a target analyte.

For many applications, the ligands that can be linked to functionalized electrodes include amino acids/peptides/proteins or nucleosides/nucleotides/nucleic acids. Specific exemplary biomolecules useful for the functionalized electrodes include, without limitation: monoclonal or polyclonal antibodies, such as IgA, IgD, IgE, IgG, IgM; antibody fragments that specifically bind to a molecule of interest (or a group of highly similar molecules of interest) to the substantial exclusion of binding to other molecules including, without limitation, proteolytic antibody fragments [such as F(ab′)2 fragments, Fab′ fragments, Fab′-SH fragments and Fab fragments as are known in the art], recombinant antibody fragments (such as sFv fragments, dsFv fragments, bispecific sFv fragments, bispecific dsFv fragments, F(ab)′2 fragments, single chain Fv proteins (“scFv”), and disulfide stabilized Fv proteins (“dsFv”)). Other useful biomolecules include diabodies, triabodies, and camelid antibodies; genetically engineered antibodies, such as chimeric antibodies, for example, humanized murine antibodies); heteroconjugate antibodies (such as, bispecific antibodies); streptavidin; receptors; enzymes; BSA; polypeptides; aptamers; and combinations thereof.

Other examples of ligands that are of use in the disclosed functionalized electrodes include allergens, antigens, such as cancer antigens, antigens derived from pathogens, such as bacterial, viral, fungal and parasitic pathogens, aptamers, chemokines, cytokines, growth factors, hormones, neuropeptides, and the like, (examples of which are given in the foregoing Listing of Terms), as well as antibodies or other molecules that bind these ligands.

In some examples, the functionalized electrodes include an antibody, a protein, a peptide, a nucleic acid molecule, or a small molecule. In some examples, the disclosed functionalized electrodes are included in an array, such as an array where different functionalized electrodes in the array are specific for different target analytes.

B. Biosensors

Also disclosed are biosensors, which include a functionalized electrode that is specific for a biomolecule of interest. In some embodiments, the biosensors are included in an array, for example an array that is capable of detecting multiple biomolecules of interest in a sample simultaneously. By way of example, such an array would include multiple, that is any number greater than one, functionalized electrodes that are specific for an biomolecule of interest. Arrays of functionalized electrodes are also disclosed.

C. Systems for Detecting a Target Analyte

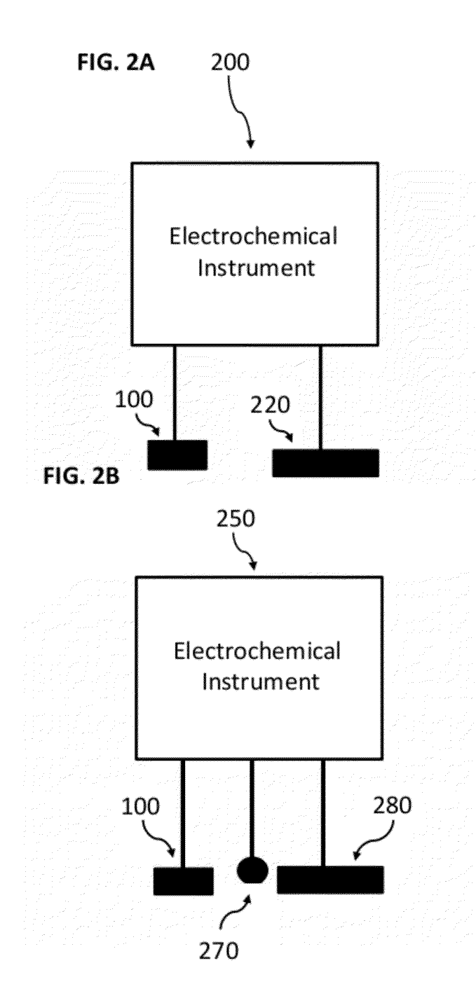

Systems for detecting a target analyte are also disclosed. Such systems include at least a first electrode and a second electrode. The first electrode, also called a working electrode, is a functionalized electrode. The system also includes an electrochemical instrument capable of applying a controlled potential between the first and second electrode and measuring the current between the two electrodes, for example a potentiostat. In some embodiments, the system includes a second electrode that is a common electrode. An example of a two electrode system is given as FIG. 2A. With reference to FIG. 2A, the system includes chemical cell 200 that includes working electrode 100 and common electrode 220. In some examples, the electrochemical instrument applies a controlled potential across the two electrodes and measures the current between working electrode 100 and common electrode 220. Other devices can be utilized with the disclosed systems, such as computers, monitors, etc. Another example of a system for detecting a target analyte is shown in FIG. 2B. With reference to FIG. 2B, the system includes chemical cell 250 that includes working electrode 100, counter electrode 270 and reference electrode 280. The electrochemical instrument measures and/or controls the voltages between electrodes 100, 270 and 280 and measures the current passing through working electrode 100.

Using the systems described herein, the reaction under investigation would either generate a measurable current (amperometric), a measurable potential or charge accumulation (potentiometric) or measurably alter the conductive properties of a medium (conductometric) between electrodes. Typically, the current is measured at a constant potential and this is referred to as amperometry. If a current is measured during controlled variations of the potential, this is referred to as voltammetry. Furthermore, the peak value of the current measured over a linear potential range is directly proportional to the bulk concentration of the analyte, or indirectly through the measurement of the electroactive species that is proportional to the concentration of analyte.

Electrochemical sensing usually requires a reference electrode, a counter or auxiliary electrode and a working electrode, also known as the sensing or redox electrode, however, as described herein, two electrode configurations can also be used. In a three electrode system, the reference electrode, commonly made from Ag/AgCl, is kept at a distance from the reaction site in order to maintain a known and stable potential. The working electrode serves as the transduction element in the biochemical reaction, while the counter electrode establishes a connection to the electrolytic solution so that a current can be applied to the working electrode.

D. Methods of Detection

In biosensing, the measurement of electrical properties for extracting information from biological systems is normally electrochemical in nature, whereby a bioelectrochemical component serves as the main transduction element. Although biosensing devices employ a variety of recognition elements, electrochemical detection techniques use predominantly enzymes. This is mostly due to their specific binding capabilities and biocatalytic activity.

Disclosed herein are methods of detecting a target analyte using a disclosed functionalized electrode. The methods include, contacting a sample with a functionalized electrode that includes a ligand that specifically binds to a target analyte, such as a biomolecule of interest, such as an allergen, antigen, such as a cancer antigen, an antigen derived from a pathogen, such as a bacterial, a viral, a fungal or a parasitic pathogen, aptamer, a chemokine, a cytokine, a growth factor, a hormone, a neuropeptide, and the like, (examples of which are given in the foregoing Listing of Terms), as well as antibodies or other molecules that bind these biomolecules. The electrodes are further contacted with a detection reagent that includes a specific binding agent that specifically binds to the target analyte. Typically the specific binding agent in the detection reagent binds to a different site on the surface of the biomolecule of interest, such that the molecules do not compete for the same binding site. The detection reagent also includes an enzyme that catalyzes a reaction with a substrate to produce an electroactive product that can be an electron donor or electron acceptor. In specific examples, the electroactive reaction product is an electron donor. In other specific examples, the electroactive reaction product is an electron acceptor. The electrodes are further contacted with the substrate that can be acted upon by the enzyme, and the current is measured between a functionalized electrode and the second electrode. Detection of a change in current between the electrodes detects the target analyte in the sample. In some embodiments a controlled potential is applied across the electrodes.

The selection of specific substrates for use in the disclosed methods, can be made using the results of cyclic voltammetry (see Example 8). By way of example, a functionalized electrode, such as any of the functionalized electrodes disclosed herein is contacted with an enzyme reaction product that is electro-active, the redox potential of the reaction product is determined by sweeping voltage between two values (V1 and V2, measured vs. a SCE) at a fixed rate. When the voltage reaches V2 the scan is reversed and the voltage is swept back to V1. The voltage is measured between a reference electrode and the working electrode, while the current is measured between the working electrode and the counter electrode. The obtained measurements are plotted as current vs. voltage, also known as a voltammogram. As the voltage is increased toward the electrochemical reduction potential of the analyte, the current will also increase. With increasing voltage toward V2 past this reduction potential, the current decreases, having formed a peak, since the oxidation potential has been exceeded. Those electroactive substrate reaction products that show a peak between about −1.5 V and about +1.5 V as measured by cyclic voltammetry are selected as electroactive substrates for use in the disclosed methods. In some examples the reaction product of the electroactive substrate has a between about −1.5 V and about +1.5 V as measured by cyclic voltammetry, such as between about −1.5 V and about +1.5 V, about −1.4 V and about +1.4 V, about −1.3 V and about +1.3 V, about −1.2 V and about +1.3 V, about −1.1V and about +1.1 V, about −1.0 V and about +1.0 V, about −0.9 V and about +0.9 V, about −1.5 V and about +1.0 V, about −1.4 V and about +1.5 V, about −1.3 V and about +1.5 V, about −1.2 V and about +1.5 V, about −0.1V and about +1.1 V, about −1.0 V and about +1.5 V, about −0.5 V and about +1.5 V, and the like, for example as measured versus a saturated calomel electrode.

In some embodiments, the enzyme is horseradish peroxidase and the substrate is a 1:1 3,3′,5,5′-tetramethylbenzidine (TMB)/H₂O₂ solution.

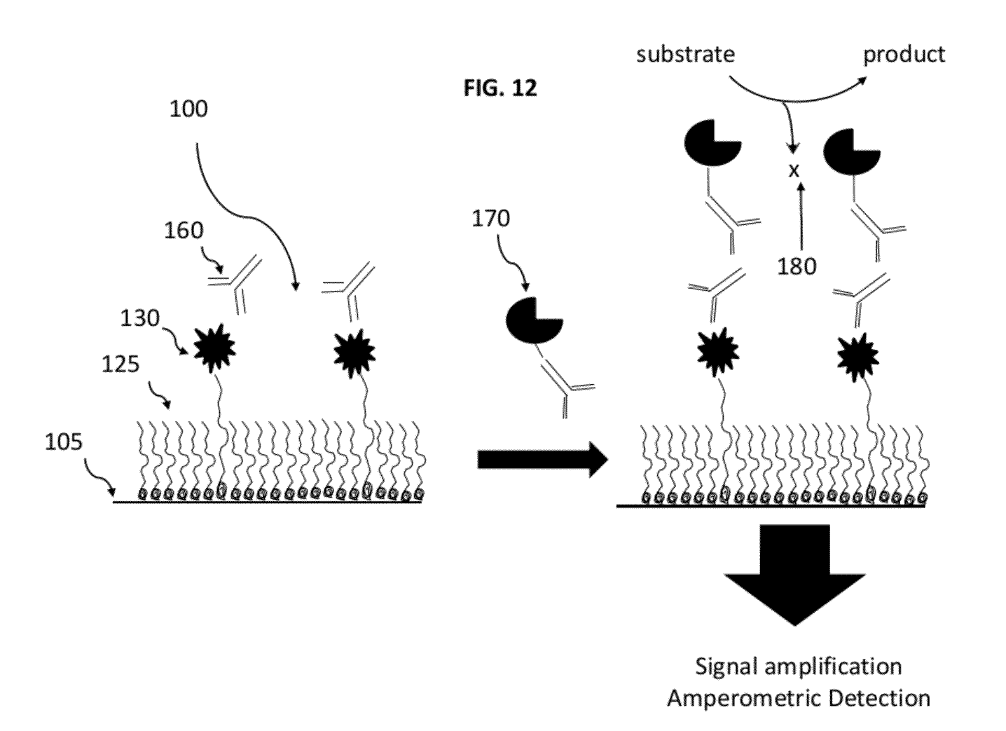

In some embodiments, the target analyte is directly detected. An example of direct detection of a target analyte is shown in FIG. 12. With reference to FIG. 12, working electrode 100 includes metal surface 105 with bound thiol compounds 125. At least one of the thiol compounds 125 is linked to ligand 130. Biological molecule 160 with affinity to ligand 130 is specifically captured at the surface of working electrode 100. Secondary reporter reagent 170 binds to biological molecule 160 and catalyzes a reaction that yields detectable product 180, enabling detection. In some embodiments, the enzyme is horseradish peroxidase and the substrate is a 1:1 3,3′,5,5′-tetramethylbenzidine (TMB)/H₂O₂ solution. Other suitable enzyme/substrate pairs for use in the disclosed methods are known to those of ordinary skill in the art. In some examples the amount and/or concentration of the target analyte in the sample is quantitated, for example relative to a reference standard.

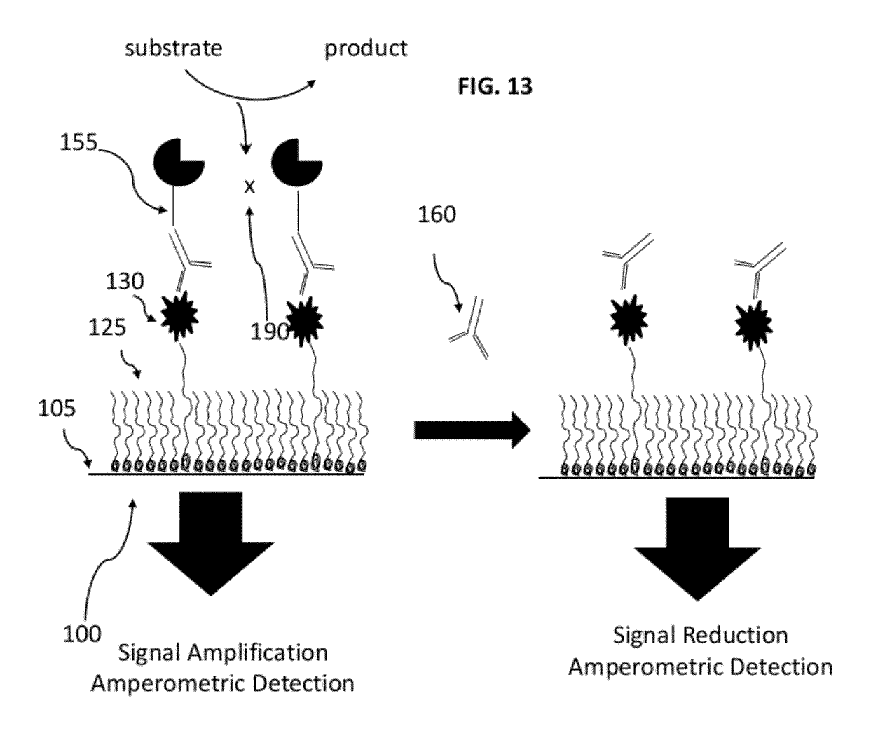

In some examples, the target analyte is indirectly detected. An exemplary method of indirect detection of a target analyte is shown in FIG. 13. With reference to FIG. 13, working electrode 100 includes metal surface 105 with bound thiol compounds 125. At least one of the thiol compounds 125 is linked to ligand 130. Competing reporter reagent 155 (that catalyzes a reaction that yields detectable product 190, enabling detection) with affinity to ligand 130 and a biological molecule 160 with affinity to ligand 130 compete for binding sites. The presence of biological molecule 160 in a sample reduces the signal, thus enabling the indirect detection of 160. In some embodiments, the enzyme is horseradish peroxidase and the substrate is a 1:1 3,3′,5,5′-tetramethylbenzidine (TMB)/H₂O₂ solution. Other suitable enzyme/substrate pairs for use in the disclosed methods are known to those of ordinary skill in the art. In some examples the amount and/or concentration of the target analyte in the sample is quantitated, for example relative to a reference standard.

Appropriate samples for use in the methods disclosed herein include any conventional sample for which information about an analyte is desired. In some examples the sample is a biological sample. For example those obtained from, excreted by or secreted by any living organism, such as eukaryotic organisms including without limitation, multicellular organisms (such as animals, including samples from a healthy or apparently healthy human subject or a human patient affected by a condition or disease to be diagnosed or investigated, such as cancer), clinical samples obtained from a human or veterinary subject, for instance blood or blood-fractions, biopsied tissue. Standard techniques for acquisition of such samples are available. See, for example Schluger et al., J. Exp. Med. 176:1327-1333 (1992); Bigby et al., Am. Rev. Respir. Dis. 133:515-18 (1986); Kovacs et al., NEJM 318:589-593 (1988); and Ognibene et al., Am. Rev. Respir. Dis. 129:929-932 (1984). Biological samples can be obtained from any organ or tissue (including a biopsy or autopsy specimen, such as a tumor biopsy) or can comprise a cell (whether a primary cell or cultured cell) or medium conditioned by any cell, tissue or organ. In some embodiments, a biological sample is a cell lysate, such as a cell lysate from cells of a tumor, such as a tumor of a subject diagnosed with cancer. Cell lysate contains many of the proteins contained in a cell. Methods for obtaining a cell lysate are well known in the art and can be found for example in Ausubel et al. (In Current Protocols in Molecular Biology, John Wiley & Sons, New York, 1998). In some examples, a sample is a sample taken from the environment, (e.g. an environmental sample), such as a water, soil, or air sample, a swab sample taken from surfaces (for instance, to check for microbial contamination), and the like.

In some examples samples are used directly. In other examples samples are purified or concentrated before they are analyzed.

E. Methods of Making a Functionalized Electrode

Also disclosed are methods of making a functionalized electrode for detecting a target analyte. In some embodiments, a method of making a functionalized electrode includes the following: contacting an electrically conducting surface with a mixture including a first thiol compound having the formula HS—(CH₂)x-(OCH₂CH₂)y-NH₂, or a salt there of, such as a chloride salt, wherein x is an integer ranging from 1-30 and y is an integer ranging from 0-10 and a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group, wherein sulfhydryl groups on the first and second thiol compounds bond with the electrically conducting surface, thereby creating a monolayer on the surface of the electrically conducting surface; contacting the monolayer on the surface of the electrically conducting surface with a heterobifunctional linker, wherein the heterobifunctional linker has a first moiety that is reactive to the NH₂ present on the first thiol compound and a second heterologous moiety that is reactive to the ligand that specifically binds a target analyte; and contacting the monolayer on the surface of the electrically conducting surface with a ligand that specifically binds a target analyte, thereby making a functionalized electrode for detecting a target analyte. In some examples, the first moiety in heterobifunctional linker is a sulfosuccinimidyl moiety. In some examples, the second moiety in heterobifunctional linker is a maleimide moiety. In specific examples the heterobifunctional linker is sulfosuccinimidyl-4-(N-maleimidomethyl)cyclohexane-1-carboxylate (Sulfo-SMCC).

In some embodiments, a method of making a functionalized electrode includes the following: contacting an electrically conducting surface with a mixture including a first thiol compound having the formula HS—(CH₂)x-(OCH₂CH₂)y-NH₂, or a salt there of, such as a chloride salt, wherein x is an integer ranging from 1-30 and y is an integer ranging from 0-10 and a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group, wherein sulfhydryl groups on the first and second thiol compounds bond with the electrically conducting surface, thereby creating a monolayer on the surface of the electrically conducting surface; contacting the monolayer on the surface of the electrically conducting surface with sulfo-NHS diazirine (sulfo-SDA), wherein the sulfo-SDA and the NH₂ chemically react to form a covalent bond; contacting the monolayer on the surface of the electrically conducting surface with a ligand that specifically binds a target analyte, exposing the monolayer on the surface of the electrically conducting surface to ultra violet radiation, thereby making a functionalized electrode for detecting a target analyte.

In some embodiments, the first thiol compound and the second thiol compound are present on the electrically conducting surface in a ratio of about 0.01:99.99 to about 99.99:0.01, such as about 0.01:99.99, about 0.1:99.9, about 1:99, about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, about 99:1, about 99.9:0.1, or about 99.99:0.01.

In some examples, the first thiol compound and the second thiol compound are covalently linked by a disulfide formed from the sulfhydryl moieties present in the two thiols, for example as a heterodimer. In some examples, the first thiol compound is presented as a homodimer, wherein the two thiols of the homodimer are linked by a disulfide formed from the sulfhydryl moieties present in the two thiols. In some examples, the second thiol compound is presented as a homodimer wherein the two thiols of the homodimer are linked by a disulfide formed from the sulfhydryl moieties present in the two thiols.

In some examples, the electrically conducting surface includes a metal surface, such as a transition metal (e.g., gold). In some examples, the ligand includes an antibody, a protein, a peptide, a nucleic acid molecule, or a small molecule that specifically binds a target analyte. In some examples, the target analyte includes an antibody, a protein, a peptide, a nucleic acid molecule, or a small molecule.

In some examples the first thiol compound has the chemical formula HS—(CH₂)x-(OCH₂CH₂)y-NH₂, or a salt there of, such as a chloride salt, wherein x is an integer ranging from 1-30 (for example x can 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30, such as 1-2, 1-3, 1-4, 1-5, 1-6, 1-7, 1-8, 1-9, 1-10, 1-11, 1-12, 1-13, 1-14, 1-15, 1-16, 1-17, 1-18, 1-19, 1-20, 1-21, 1-22, 1-23, 1-24, 1-25, 1-26, 1-27, 1-28, 1-29, 1-30, 2-3, 2-4, 2-5, 2-6, 2-7, 2-8, 2-9, 2-10, 2-11, 2-12, 2-13, 2-14, 2-15, 2-16, 2-17, 2-18, 2-19, 2-20, 2-21, 2-22, 2-23, 2-24, 2-25, 2-26, 2-27, 2-28, 2-29, 2-30, 3-4, 3-5, 3-6, 3-7, 3-8, 3-9, 3-10, 3-11, 3-12, 3-13, 3-14, 3-15, 3-16, 3-17, 3-18, 3-19, 3-20, 3-21, 3-22, 3-23, 3-24, 3-25, 3-26, 3-27, 3-28, 3-29, 3-30, 4-5, 4-6, 4-7, 4-8, 4-9, 4-10, 4-11, 4-12, 4-13, 4-14, 4-15, 4-16, 4-17, 4-18, 4-19, 4-20, 4-21, 4-22, 4-23, 4-24, 4-25, 4-26, 4-27, 4-28, 4-29, 4-30, 5-6, 5-7, 5-8, 5-9, 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-7, 6-8, 6-9, 6-10, 6-11, 6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-8, 7-9, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-9, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-19, 10-20, 10-21, 10-22, 10-23, 10-24, 10-25, 10-26, 10-27, 10-28, 10-29, 10-30, 11-12, 11-13, 11-14, 11-15, 11-16, 11-17, 11-18, 11-19, 11-20, 11-21, 11-22, 11-23, 11-24, 11-25, 11-26, 11-27, 11-28, 11-29, 11-30, 12-13, 12-14, 12-15, 12-16, 12-17, 12-18, 12-19, 12-20, 12-21, 12-22, 12-23, 12-24, 12-25, 12-26, 12-27, 12-28, 12-29, 12-30, 13-14, 13-15, 13-16, 13-17, 13-18, 13-19, 13-20, 13-21, 13-22, 13-23, 13-24, 13-25, 13-26, 13-27, 13-28, 13-29, 13-30, 14-15, 14-16, 14-17, 14-18, 14-19, 14-20, 14-21, 14-22, 14-23, 14-24, 14-25, 14-26, 14-27, 14-28, 14-29, 14-30, 15-16, 15-17, 15-18, 15-19, 15-20, 15-21, 15-22, 15-23, 15-24, 15-25, 15-26, 15-27, 15-28, 15-29, 15-30, 16-17, 16-18, 16-19, 16-20, 16-21, 16-22, 16-23, 16-24, 16-25, 16-26, 16-27, 16-28, 16-29, 16-30, 17-18, 17-19, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30 20-21, 10-22, 20-23, 20-24, 20-25, 20-26, 20-27, 20-28, 20-29, 20-30, 21-22, 11-23, 21-24, 21-25, 21-26, 21-27, 21-28, 21-29, 21-30, 22-23, 22-24, 22-25, 22-26, 22-27, 22-28, 22-29, 22-30, 23-24, 23-25, 23-26, 23-27, 23-28, 23-29, 23-30 24-25, 24-26, 24-27, 24-28, 24-29, 24-30, 25-26, 25-27, 25-28, 25-29, 25-30, 26-27, 26-28, 26-29, 26-30, 28-29, 28-30, or 29 30) and y is an integer ranging from 0-10 (for example y can be 1, 2, 3, 4, 5, 6, 7, 8, 9, 10, such as for example x can be 1-2, 1-3, 1-4, 1-5, 1-6, 1-7, 1-8, 1-9, 1-10, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, or 9-10).

In some examples, the second thiol compound has the chemical formula HS—(CH₂)n-(OCH₂CH₂)m-R, wherein n is an integer ranging from 1-30 (for example n can 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30, such as 1-2, 1-3, 1-4, 1-5, 1-6, 1-7, 1-8, 1-9, 1-10, 1-11, 1-12, 1-13, 1-14, 1-15, 1-16, 1-17, 1-18, 1-19, 1-20, 1-21, 1-22, 1-23, 1-24, 1-25, 1-26, 1-27, 1-28, 1-29, 1-30, 2-3, 2-4, 2-5, 2-6, 2-7, 2-8, 2-9, 2-10, 2-11, 2-12, 2-13, 2-14, 2-15, 2-16, 2-17, 2-18, 2-19, 2-20, 2-21, 2-22, 2-23, 2-24, 2-25, 2-26, 2-27, 2-28, 2-29, 2-30, 3-4, 3-5, 3-6, 3-7, 3-8, 3-9, 3-10, 3-11, 3-12, 3-13, 3-14, 3-15, 3-16, 3-17, 3-18, 3-19, 3-20, 3-21, 3-22, 3-23, 3-24, 3-25, 3-26, 3-27, 3-28, 3-29, 3-30, 4-5, 4-6, 4-7, 4-8, 4-9, 4-10, 4-11, 4-12, 4-13, 4-14, 4-15, 4-16, 4-17, 4-18, 4-19, 4-20, 4-21, 4-22, 4-23, 4-24, 4-25, 4-26, 4-27, 4-28, 4-29, 4-30, 5-6, 5-7, 5-8, 5-9, 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-7, 6-8, 6-9, 6-10, 6-11, 6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-8, 7-9, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-9, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-19, 10-20, 10-21, 10-22, 10-23, 10-24, 10-25, 10-26, 10-27, 10-28, 10-29, 10-30, 11-12, 11-13, 11-14, 11-15, 11-16, 11-17, 11-18, 11-19, 11-20, 11-21, 11-22, 11-23, 11-24, 11-25, 11-26, 11-27, 11-28, 11-29, 11-30, 12-13, 12-14, 12-15, 12-16, 12-17, 12-18, 12-19, 12-20, 12-21, 12-22, 12-23, 12-24, 12-25, 12-26, 12-27, 12-28, 12-29, 12-30, 13-14, 13-15, 13-16, 13-17, 13-18, 13-19, 13-20, 13-21, 13-22, 13-23, 13-24, 13-25, 13-26, 13-27, 13-28, 13-29, 13-30, 14-15, 14-16, 14-17, 14-18, 14-19, 14-20, 14-21, 14-22, 14-23, 14-24, 14-25, 14-26, 14-27, 14-28, 14-29, 14-30, 15-16, 15-17, 15-18, 15-19, 15-20, 15-21, 15-22, 15-23, 15-24, 15-25, 15-26, 15-27, 15-28, 15-29, 15-30, 16-17, 16-18, 16-19, 16-20, 16-21, 16-22, 16-23, 16-24, 16-25, 16-26, 16-27, 16-28, 16-29, 16-30, 17-18, 17-19, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30 20-21, 10-22, 20-23, 20-24, 20-25, 20-26, 20-27, 20-28, 20-29, 20-30, 21-22, 11-23, 21-24, 21-25, 21-26, 21-27, 21-28, 21-29, 21-30, 22-23, 22-24, 22-25, 22-26, 22-27, 22-28, 22-29, 22-30, 23-24, 23-25, 23-26, 23-27, 23-28, 23-29, 23-30 24-25, 24-26, 24-27, 24-28, 24-29, 24-30, 25-26, 25-27, 25-28, 25-29, 25-30, 26-27, 26-28, 26-29, 26-30, 28-29, 28-30, or 29 30) and m is an integer ranging from 0-10 (for example m can be 1, 2, 3, 4, 5, 6, 7, 8, 9, 10, such as 1-2, 1-3, 1-4, 1-5, 1-6, 1-7, 1-8, 1-9, 1-10, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, or 9-10).

F. Kits

Kits are also provided herein. Kits for detecting analytes of interest contain a one or more of the disclosed biosensors. In some embodiments, a kit includes instructional materials disclosing means of detecting analytes of interest. The instructional materials may be written, in an electronic form (such as a computer diskette or compact disk) or may be visual (such as video files). The kits may also contain detection reagents and substrates that have electroactive reaction product. The kits may also include additional components to facilitate the particular application for which the kit is designed. Thus, for example, the kit may additionally contain buffers and other reagents routinely used for the practice of a particular method. Such kits and appropriate contents are well known to those of skill in the art. In some examples the kits contain controls, for examples control solutions containing a known amount or concentration of a target analyte, for example as a means calibrate the biosensors included in kits. The kit may contain components for automated assay testing, and automated data collection that would be useful in a rapid, point-of-care setting.

The present disclosure is illustrated by the following non-limiting Examples.

### EXAMPLES

### Example 1

### Fabrication of Sensors Prepared Using Allergen Protein Phl p5

This example describes the fabrication of exemplary biosensors using gold as the substrate for functionalization. A schematic representation of the functionalized electrode of this example is shown as FIG. 1C.

Clean gold arrays presenting 16 sets of 3-electrode patterns obtained from Genefluidics were immersed in 0.10 mM ethanolic solutions of a mixture of the thiols EG3 (HS—(CH₂)₁₁—(OCH₂CH2)₃—OH) and EG5-N(HS—(CH₂)₁₁—(OCH₂CH₂)₅—NH₂) for 18 hours at room temperature. In this example, EG5-N constituted 0.1% of the mixture and EG3 constituted 99.9% of the mixture. The functionalized surfaces were rinsed with water and ethanol and dried under a stream of Argon gas. Fluidic wells were applied to the array. Next, a solution of sulfo-NHS diazirine (sulfo-SDA) (Pierce) 1 mg/mL in 1:1 H2O:phosphate buffered saline (PBS) was prepared and applied dropwise to each working electrode on the array and allowed to incubate for 30 minutes in a dark, humid chamber. The arrays were rinsed with water and dried under a stream of Argon gas. Allergen protein Phl p5 (Indoor Biotech) was diluted in PBS buffer to a final concentration of 100 ug/mL. The solution was applied dropwise to each working electrode on the array, which was then positioned under a UV lamp source (UVP, 3-UV, 8 watts, set to 365 nm and positioned approximately 1.5 cm from the surface of the array). The arrays were exposed to UV light for 35 minutes, and then rinsed 3 times with (phosphate buffered saline plus Tween®-20 (PBST). The biosensor produced was tested for analyte binding. While the emphasis is on the biosensors produced in by the methods described in this Example, these methods can be applied to test other biosensors.

A 5% solution of bovine serum albumin (BSA) in PBS was applied to each well from the array (approximately 50 μL) and incubated for 60 minutes. The wells were rinsed once with PBST. Analyte standards of known concentration were created by dosing monoclonal mouse anti-Phl p5 IgG (Indoor Biotech) into a dilution of 1:100 mouse serum:PBST. In triplicate, 50 μL of each standard was applied to wells on the array, and incubated for 45 minutes at room temperature. Next, wells were rinsed 3 times with PBST. Reporter solutions were prepared by diluting polyclonal goat anti-mouse IgG HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

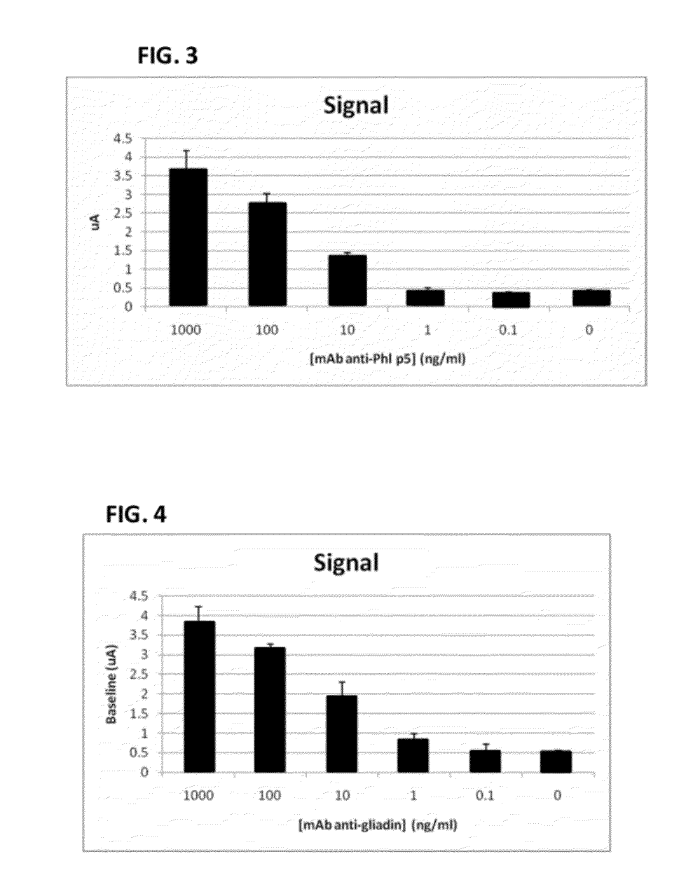

The potentiostat (Gamry Instruments Reference 600) was used to collect data in Step Amperometry mode. The array was connected to the potentiostat to form a 3-electrode electrochemical cell (a schematic of an exemplary 3 electrode electrochemical cell is show in FIG. 2B). PBST was removed from the well, and 50 μL of a 1:1 3,3′,5,5′-tetramethylbenzidine (TMB)/H₂0₂ solution (Pierce TMB substrate kit) was applied to the well. This was held for 10 seconds, and then a fixed bias of −0.400 V (vs. gold pseudo-reference) was held for 30 seconds and current was measured in real time. The average current at time points between 28-30 seconds was recorded and used as a measure of signal. The average signal with standard deviation was plotted as a function of analyte dose concentration in the mouse serum dilution. The result of this test is shown in FIG. 3.

### Example 2

### Sensors Prepared Using Peptide Epitope of Gliadin

This example describes the use of an epitope of the protein allergen gliadin to produce biosensors that are specific for the antibodies or other molecules that bind gliadin. This example demonstrates that the disclosed biosensors can be made to detect different substrates present in a solution, for example as part of an array of individual biosensors located on a single device.

Clean gold arrays presenting 16 sets of 3-electrode patterns (Genefluidics) were immersed in a 0.10 mM ethanolic solution of a mixture of the thiols EG3 and EG5-N for 18 hours at room temperature. In this example, EG5-N constituted 0.625% of the mixture and EG3 constituted 99.375% of the mixture. Next, these surfaces were rinsed with water and ethanol and dried under a stream of Argon gas. Fluidic wells were applied to the array. Next, a solution of sulfo-SDA (Pierce) 1 mg/mL in 1:1 H₂O:PBS was prepared and applied dropwise to each working electrode on the array and allowed to incubate for 30 minutes in a dark, humid chamber. The arrays were rinsed with water and dried under a stream of Argon. A synthetic peptide (Peptide #2 from Virogenomics library, with sequence biotin-KLQPFPQPELPYPQPQP, SEQ ID NO: 1) representing an epitope sequence from the wheat protein gliadin was diluted in PBS buffer to a final concentration of 100 ug/mL. The solution was applied dropwise to each working electrode on the array, which was then positioned under a UV lamp source (UVP, 3-UV, 8 watts, set to 365 nm and positioned approximately 1.5 cm from the surface of the array). The arrays were exposed to UV light for 30 minutes, and then rinsed 3 times with PBST. The biosensor produced was tested for analyte binding.

A 5% solution of BSA in PBS was applied to each well from the array (approximately 50 μL) and incubated for 60 minutes. The wells were rinsed once with PBST. Analyte standards of known concentration were created by dosing monoclonal mouse anti-gliadin IgG (Indoor Biotech) into a dilution of 1:100 mouse serum:PBST. In triplicate, 50 μL of each standard was applied to wells on the array, and incubated for 45 minutes at room temperature. Next, wells were rinsed 3 times with PBST. Reporter solutions were prepared by diluting polyclonal goat anti-mouse IgG HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

The potentiostat (Gamry Instruments Reference 600) was used to collect data in Step Amperometry mode. The array was connected to the potentiostat to form a 3-electrode electrochemical cell. PBST was removed from the well, and 50 μL of a 1:1 TMB/H₂0₂ solution (Pierce TMB substrate kit) was applied to the well. This was held for 10 seconds, and then a fixed bias of −0.400 V (vs. gold pseudo-reference) was held for 30 seconds and current was measured in real time. The average current at time points between 28-30 s was recorded and used as a measure of signal. The average signal with standard deviation was plotted as a function of analyte dose concentration in the mouse serum dilution. The result is shown in FIG. 4.

### Example 3

### Sensors Prepared Using Capture Antibody Monoclonal Anti-IL10

This examples describes the use of an antibody, in this case an antibody to interleukin-10 (IL-10), to produce biosensors. This example demonstrates that the disclosed biosensors can be made to detect protein analytes in a solution using specific biding molecules, such as antibodies. This example is also illustrative of a sandwich-type assay.

Clean gold arrays presenting 16 sets of 3-electrode patterns (Genefluidics) were immersed in 0.10 mM ethanolic solutions of a mixture of the thiols EG3 and EG5-N for 18 hours at room temperature. In this example, EG5-N was present in the mixture at 0.1% and EG3 was present in the mixture at 99.9%. Next, these surfaces were rinsed with water and ethanol and dried under a stream of Argon gas. Fluidic wells were applied to the array. Next, a solution of sulfo-SDA (Pierce) 1 mg/mL in 1:1 H₂0:PBS was prepared and applied dropwise to each working electrode on the array and allowed to incubate for 30 minutes in a dark, humid chamber. The arrays were rinsed with water and dried under a stream of Argon gas. Capture antibody specific for IL-10 (Pierce) was diluted in PBS buffer to a final concentration of 100 ug/mL. The solution was applied dropwise to each working electrodes on the array, which was then positioned under a UV lamp source (UVP, 3-UV, 8 watts, set to 365 nm and positioned approximately 1.5 cm from the surface of the array). The arrays were exposed to UV light for 35 minutes, and then rinsed 3 times with PBST. The biosensor produced was tested for analyte binding.

A 5% solution of BSA in PBS was applied to each well from the array (approximately 50 μL) and incubated for 60 minutes. The wells were rinsed once with PBST. Analyte standards of known concentration were created by dosing human recombinant IL-10 (Pierce) into a dilution of 1:100 pooled normal human serum:PBST (supplied by Innovative Research, Novi, Mich.). In triplicate, 50 μL of each standard was applied to wells on the array, and incubated for 45 minutes at room temperature. Next, wells were rinsed 3 times with PBST. Biotinylated detection antibody bi-anti-IL10 (Pierce) was diluted to a working concentration of 1 ug/mL in PBST. 50 μL was applied to each well and incubated for 30 minutes. The wells were rinsed 3 times with PBST. Next, reporter solutions were prepared by diluting Streptavidin-HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

The potentiostat (Gamry Instruments Reference 600) was used to collect data in Step Amperometry mode. The array was connected to the potentiostat to form a 3-electrode electrochemical cell. PBST was removed from the well, and 50 μL of a 1:1 TMB/H202 solution (Pierce TMB substrate kit) was applied to the well. This was held for 10 seconds, and then a fixed bias of −0.400 V (vs. gold pseudo-reference) was held for 30 seconds and current was measured in real time. The average current at timepoints between 28-30 s was recorded and used as a measure of signal. The average signal with standard deviation was plotted as a function of analyte dose concentration in the mouse serum dilution.

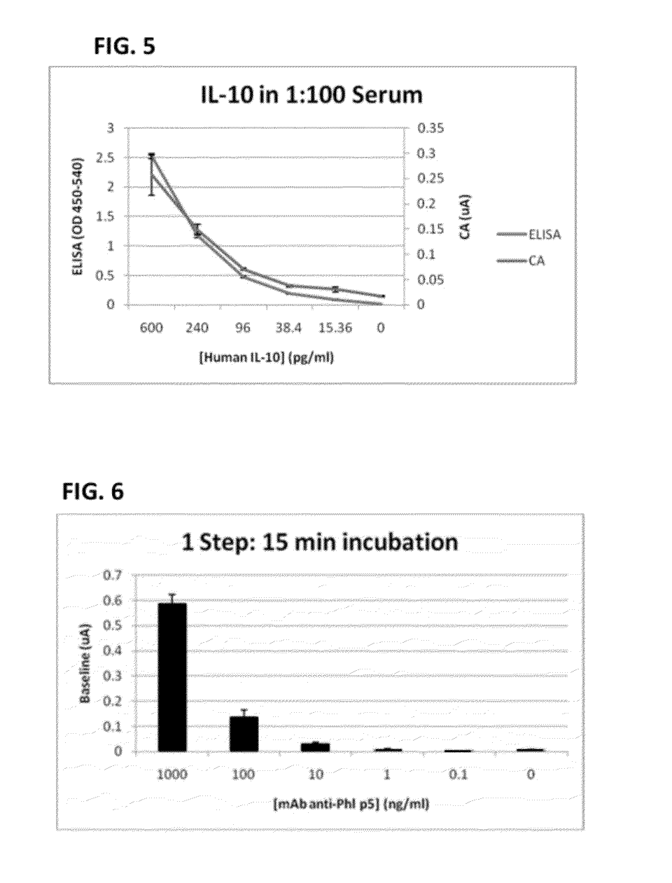

To test the sensitivity of the disclosed biosensors, as exemplified by the device produce according to Example 5, a commercial ELISA kit (Pierce) for human IL-10 was obtained. The manufacturer's instructions were followed to determine the concentrations of IL-10 present in the samples tested in this Example. The performance of this kit (OD 450 values) was compared against the results obtained with the biosensor disclosed in this example. The results of this comparison are shown in FIG. 5. As shown in FIG. 5, the sensitivity of the disclosed biosensors is comparable to the ELISA assay.

### Example 4

### Assay Optimization to Conduct a <30 Minute Ligand Binding Assay with Reporter

This example describes one of the advantages of the disclosed biosensors over traditional ELISA type assays, which is that they can be performed in a relatively short period of time, for example in less than 30 minutes, compared to an ELISA, which may take more than a day.

In this example, arrays prepared according to Example 1 were used. A 5% solution of BSA in PBS was applied to each well (approximately 50 μL) and incubated for 60 minutes. The wells were rinsed once with PBST. Analyte standards of known concentration were created by dosing monoclonal mouse anti-Phl p5 IgG (Indoor Biotech) into a dilution of 1:100 mouse serum:PBST+5% BSA to prepare final standards of 1000, 100, 10, 1, 0.1 and 0 ng/ml mAb anti-Phl p5. 180 μL aliquots of each analyte concentration were removed and 6.8 μL 0.4 mg/ml goat anti mouse-HRP was added to each aliquot just prior to adding to the wells for a 15 minutes incubation. Next, wells were rinsed 3 times with PBST. The array was transferred to a Gamry potentiostat connector for recording electrochemical data.

The potentiostat (Gamry Instruments Reference 600) was used to collect data in Step Amperometry mode. The array from was connected to the potentiostat to form a 3-electrode electrochemical cell. PBST was removed from the well, and 50 μL of a 1:1 TMB/H202 solution (Pierce TMB substrate kit) was applied to the well. This was held for 10 seconds, and then a fixed bias of −0.400 V (vs. gold pseudo-reference) was held for 30 seconds and current was measured in real time. The average current at timepoints between 28-30 s was recorded and used as a measure of signal. The average signal with standard deviation was plotted as a function of analyte dose concentration in the mouse serum dilution. The results of this Example are shown in FIG. 6.

### Example 5

### Biosensors Prepared with Ovalbumin Using Diazirine and EG SAMs

This example describes exemplary methods of attaching biomolecules to electrodes using ovalbumin and EG self-assembled monolayers.

Clean gold arrays presenting 16 sets of 3-electrode patterns (Genefluidics) were immersed in 0.10 mM ethanolic solutions of a mixture of the thiols EG3 and EG5-N for 18 hours at room temperature. In this example, EG5-N was present in the mixture at 3% and EG3 was present in the mixture at 97%. Next, these surfaces were rinsed with water and ethanol and dried under a stream of Argon gas. Fluidic wells were applied to the array. Next, a solution of sulfo-SDA (Pierce) 1 mg/mL in 1:1 H20:PBS was prepared and applied dropwise to each working electrode on the array and allowed to incubate for 30 minutes in a dark, humid chamber. The arrays were rinsed with water and dried under a stream of Argon gas. Ovalbumin (Pierce) was diluted in PBS buffer to a final concentration of 100 ug/mL. The solution was applied dropwise to each working electrodes on the array. The droplets were allowed to dry under dark, ambient conditions. The array was then positioned under a UV lamp source (UVP, 3-UV, 8 watts, set to 365 nm and positioned approximately 1.5 cm from the surface of the array). The arrays were exposed to UV light for 30 minutes, and then rinsed 3 times with PBST.

A 5% solution of BSA in PBS was applied to each well from the array in Example 1 (approximately 50 μL) and incubated for 60 minutes. The wells were rinsed once with PBST. Analyte standards of known concentration were created by dosing polyclonal anti-ovalbumin (Pierce) into a dilution of 1:100 normal rabbit serum:PBST. In triplicate, 50 μL of each standard was applied to wells on the array, and incubated for 45 minutes at room temperature. Next, wells were rinsed 3 times with PBST. Next, reporter solutions were prepared by diluting goat anti-rabbit-HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

The potentiostat (Gamry Instruments Reference 600) was used to collect data in amperometry mode. The array from was connected to the potentiostat to form a 3-electrode electrochemical cell. PBST was removed from the well, and 25 μL of H202 solution (Pierce TMB substrate kit) was applied to the well. Then a fixed bias of −0.400 V (vs. gold pseudo-reference) was applied. This was held for 10 seconds, and a 25 μL sample of TMB (Pierce TMB substrate kit) was injected. Current was collected in real time for an additional 50 seconds. The peak height in current obtained after injection was used as a measure of signal. The average signal over multiple experiments with standard deviation was plotted as a function of analyte dose concentration in the rabbit serum dilution.

### Example 6

### Sensors Prepared with Ovalbumin Using NHS/EDC Coupling to Carboxylated MOA SAMs

This example describes the coupling of biomolecules to the surface of electrodes using alternative chemistry.

Clean gold arrays presenting 16 sets of 3-electrode patterns (Genefluidics) were immersed in 0.10 mM ethanolic solutions of a mixture of the thiols mercaptoocanoic acid (MOA) and mercaptohexanol (MCH) 18 hours at room temperature. In this example, MOA was present in 10% of the mixture and MCH was present in the mixture at 90%. Next, these surfaces were rinsed with water and ethanol and dried under a stream of Ar gas. Fluidic wells were applied to the array. Next, a solution of 30 mg EDC and 8 mg NHS was dissolved in 1 mL DI water and applied dropwise to each working electrode on the array and allowed to incubate for 30 minutes in a humid chamber. The arrays were rinsed with water and dried under a stream of Ar. Ovalbumin (Pierce) was diluted in PBS buffer to a final concentration of 100 ug/mL. The solution was applied dropwise to each working electrodes on the array. The array was incubated in a humid chamber for 2 hours, and then rinsed 3 times with PBST. Next a solution of 0.1% ethanolamine in carbonate buffer pH 9.5 was applied to the working electrode for 10 minutes. The surfaces were rinsed with PBS.

A 5% solution of BSA in PBS was applied to each well from the array (approximately 50 μL) and incubated for 60 minutes. The wells were rinsed once with PBST. Analyte standards of known concentration were created by dosing polyclonal anti-ovalbumin (Pierce) into a dilution of 1:100 normal rabbit serum:PBST. In triplicate, 50 μL of each standard was applied to wells on the array, and incubated for 45 minutes at room temperature. Next, wells were rinsed 3 times with PBST. Next, reporter solutions were prepared by diluting goat anti-rabbit-HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

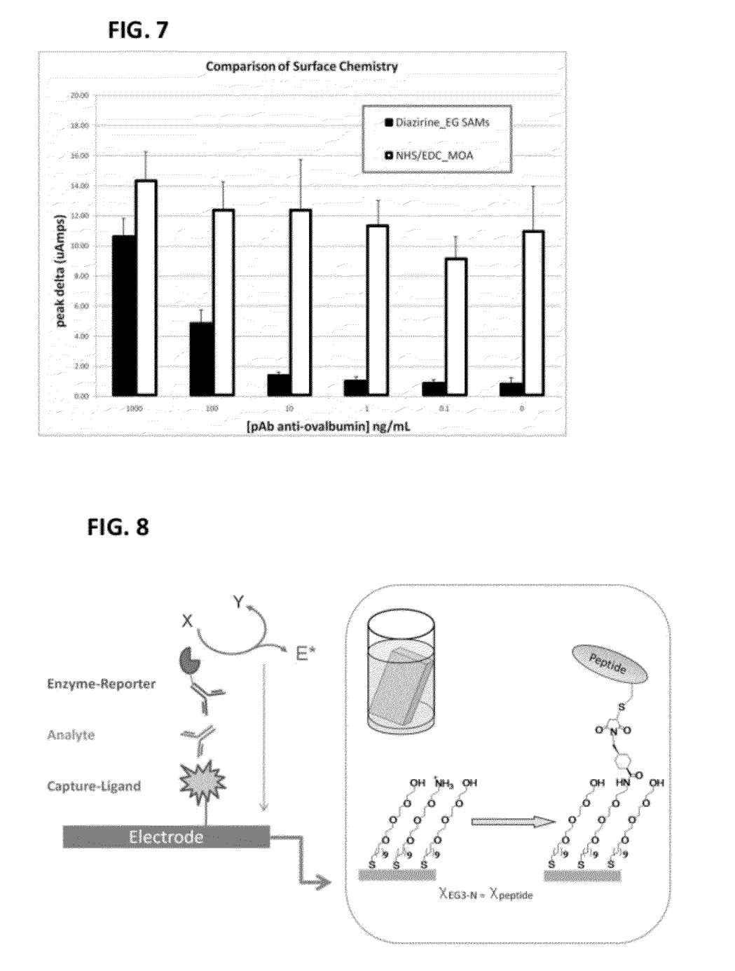

The potentiostat (Gamry Instruments Reference 600) was used to collect data in amperometry mode. The array was connected to the potentiostat to form a 3-electrode electrochemical cell. PBST was removed from the well, and 25 μL of H202 solution (Pierce TMB substrate kit) was applied to the well. Then a fixed bias of −0.400 V (vs. gold pseudo-reference) was applied. This was held for 10 seconds, and a 25 μL sample of TMB (Pierce TMB substrate kit) was injected. Current was collected in real time for an additional 50 seconds. The peak height in current obtained after injection was used as a measure of signal. The average signal over multiple experiments with standard deviation was plotted as a function of analyte dose concentration in the rabbit serum dilution. The results of this example are shown in FIG. 7 as compared to the similar results obtained from Example 5.

### Example 7

### Fabrication of Sensors Prepared Using Cysteine-Modified Peptide Epitope for Gliadin

This example describes exemplary methods for preparing the disclosed biosensors. A schematic representation of preparing biosensors as described in this example is shown in FIG. 8.

In this example, Clean gold arrays presenting 16 sets of 3-electrode patterns (Genefluidics) were immersed in 0.10 mM ethanolic solutions of a mixture of the thiols EG3 and EG5-N for 18 hours at room temperature. EG5-N was present at 0.625% and EG3 was present at 99.375%. Next, these surfaces were rinsed with water and ethanol and dried under a stream of Argon gas. Fluidic wells were applied to the array. Next, a solution of sulfo-SMCC (Pierce) 1 mg/mL in 1:1 H₂O:PBS was prepared and applied dropwise to each working electrode on the array and allowed to incubate for 30 minutes in a humid chamber. The arrays were rinsed with water and dried under a stream of Argon gas. A peptide epitope for gliadin was synthesized such that it had a cysteine-modification (Virogenomics peptide library BC-001) and this material was diluted in PBS buffer to a final concentration of 100 ug/mL. The solution was applied dropwise to each working electrodes on the array, and allowed to incubate for 10 minutes. Then rinsed with H₂O and dried. Next, a 10 mM solution of 2-mercaptoethanol in PBS was added to each well and allowed to react for 10 minutes. Finally the array was rinsed with PBS.

Next, a 5% solution of BSA in PBST was applied to each well from the array (approximately 50 μL) and incubated for 60 minutes. The wells were rinsed once with PBST. Analyte standards of known concentration were created by dosing monoclonal mouse anti-gliadin IgG (Santa Cruz Biotech) into a dilution of 1:100 mouse serum:PBST. In triplicate, 50 μL of each standard was applied to wells on the array, and incubated for 45 minutes at room temperature. Next, wells were rinsed 3 times with PBST. Reporter solutions were prepared by diluting polyclonal goat anti-mouse IgG HRP (Pierce) to 1 ug/mL in PBST. 50 μL of this solution was applied to each well on the array, and incubated for 30 minutes at room temperature. Wells were then rinsed 3 times with PBST. The array was transferred to a Gamry potentiostat connector for recording electrochemical data.

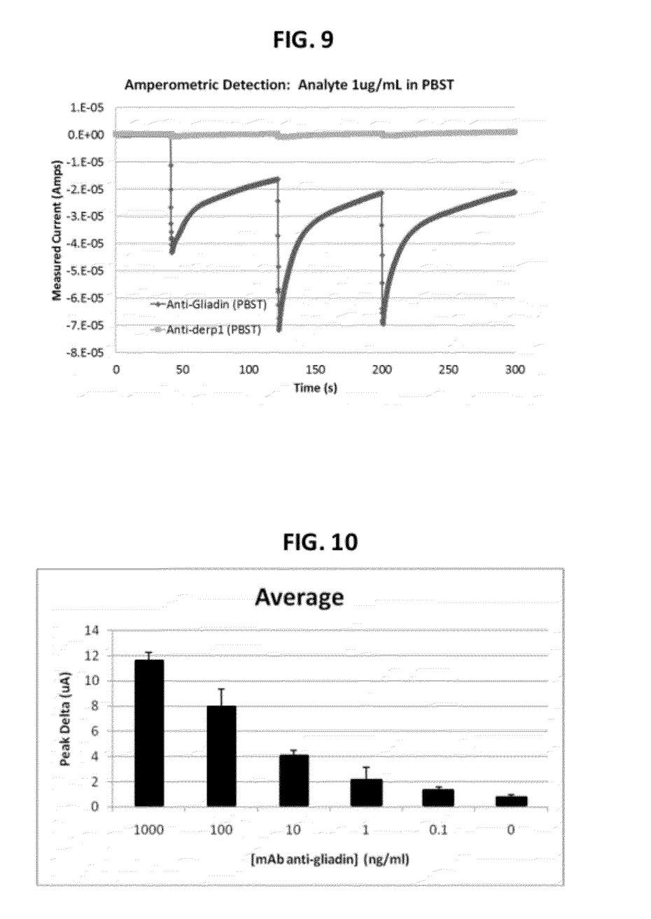

The potentiostat (Gamry Instruments Reference 600) was used to collect data in Step Amperometry mode. The array from was connected to the potentiostat to form a 3-electrode electrochemical cell. PBST was removed from the well, and 25 μL of H202 solution (Pierce TMB substrate kit) was applied to the well. A fixed bias of −0.4 V (vs. gold pseudo-reference) was held for 10 seconds to collect an initial baseline current, and 25 μL of TMB (Pierce TMB substrate kit) was injected into the well. During this injection the current was measured in real time, and the magnitude of the injection peak was determined and used as the sensor signal (see FIG. 9). The average signal with standard deviation was plotted as a function of analyte dose concentration in the mouse serum dilution. The results of this Example are shown in FIG. 10.

### Example 8

### Compatibility Screening of Redox Mediators with EG SAMs, Fabrication of Sensors Prepared with Oligo(Ethylene Glycol)-Terminated Thiols

This example describes compatibility screening of redox mediators.

Clean gold arrays presenting 16 sets of 3-electrode patterns (Genefluidics) were immersed in 0.10 mM ethanolic solutions of EG3 for 18 hours at room temperature. Next, these surfaces were rinsed with water and ethanol and dried under a stream of Ar gas. Fluidic wells were applied to the array. Clean gold arrays were left untreated. Fluidic wells were applied to the array.

A potentiostat (Gamry Instruments Reference 600) was used to collect data in Step Amperometry mode. The arrays from was connected to the potentiostat to form a 3-electrode electrochemical cell. 50 μL of probe solution was added to each well on the array, and cyclic voltammetry was performed. Clean gold arrays were left untreated.

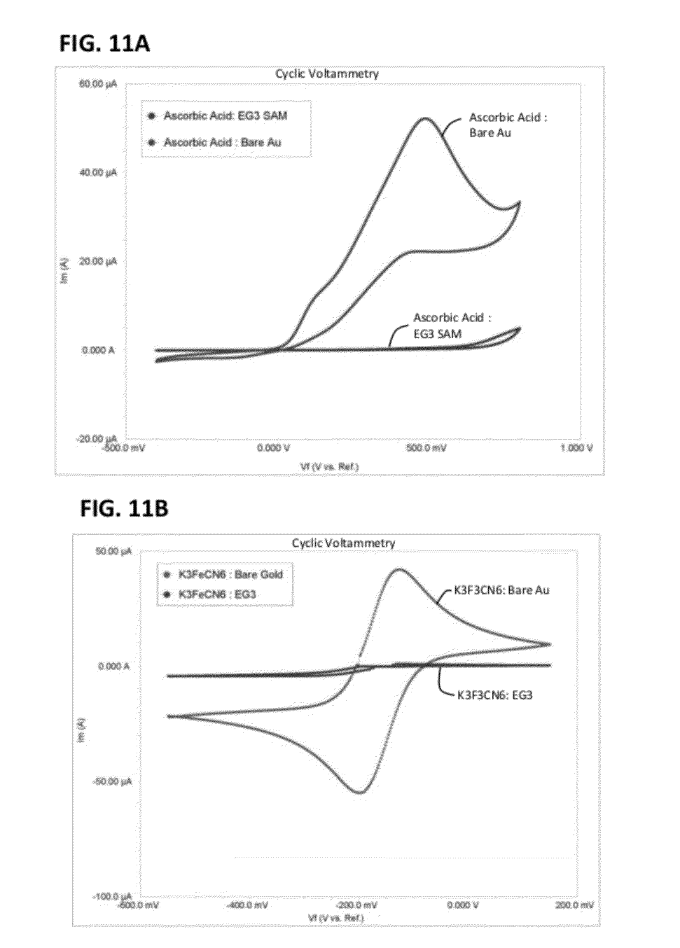

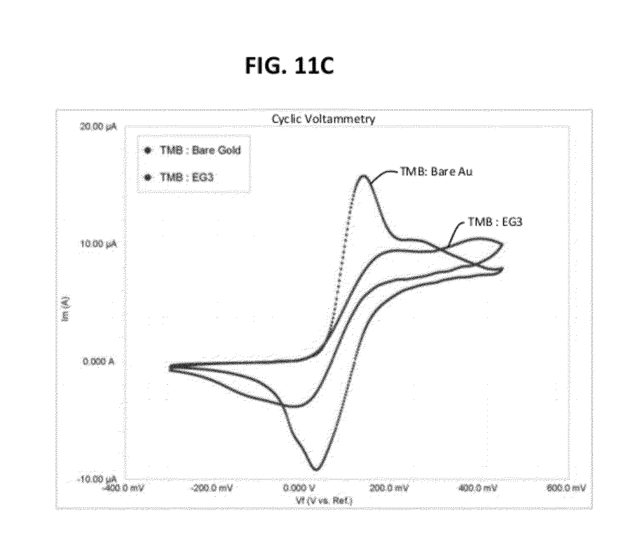

Probe solutions included K3FeCN6, ascorbic acid, and TMB. Inspection of the voltammograms obtained via the cyclic voltammetry as shown in FIGS. 11A-C. FIG. 11 yielded several observations. First, all redox probes had measurable electrochemical activity when using bare gold electrodes. Second, the specific combination of EG coated electrodes and TMB probe solution also demonstrated measurable electrochemical activity. Third, the activity of K3FeCN6 and ascorbic acid was reduced when measured using EG coated electrodes.

### Example 9

### Fabrication of Sensors Prepared Using Allergens for the Quantitative Measurement of Allergen-Specific IgE and Subsequent Diagnosis of Allergies

This example describes exemplary methods for preparing the disclosed biosensors. A schematic representation of preparing biosensors as described in this example is shown in FIG. 1C. While the emphasis of the biosensors produced in this example is for the measurement of total IgE and allergen-specific IgE, the methods could be used to detect and measure the concentration of other analytes.

In this example, clean gold arrays presenting 16 sets of 3-electrode patterns (Genefluidics) were immersed in 0.10 mM ethanolic solutions of a mixture of thiols EG3 and EG5-N for 18 hours at room temperature. EG5-N was present at 0.1% and EG3 was present at 99.9%. The functionalized surfaces were rinsed with water and ethanol, and dried under a stream of argon gas. Fluidic wells were applied to the array. Next, a solution of sulfo-NHS diazirine (sulfo-SDA) (Pierce) 1 mg/mL in 1:1 H₂O:phosphate buffered saline (PBS) was prepared and applied dropwise to each working electrode on the array, and allowed to incubate for 30 minutes in a dark, humid chamber. The arrays were rinsed with water and dried under a stream of argon gas.

Anti-IgE (Abd Serotec) was diluted in PBS buffer to a final concentration of 100 μg/mL.

For the biosensor arrays used to evaluate serum from anonymous allergy patients, the allergens Phl p5, Alt a1, or Fel d1 (IndoorBiotech) were diluted in PBS buffer to a final concentration of 100 μg/mL.

The solutions were applied dropwise to working electrodes on the array, which was then positioned under a UV lamp source (UVP, 3-UV, 8 watts, set to 365 nm and positioned approximately 1.5 cm from the surface of the array). The arrays were exposed to UV light for 35 minutes, and then rinsed 3 times with (phosphate buffered saline plus Tween®-20 (PBST). The biosensor produced was tested for analyte binding. A 5% solution of bovine serum albumin (BSA) in PBS was applied to each well from the array (approximately 50 μL) and incubated for 60 minutes. The wells were rinsed once with PBST.

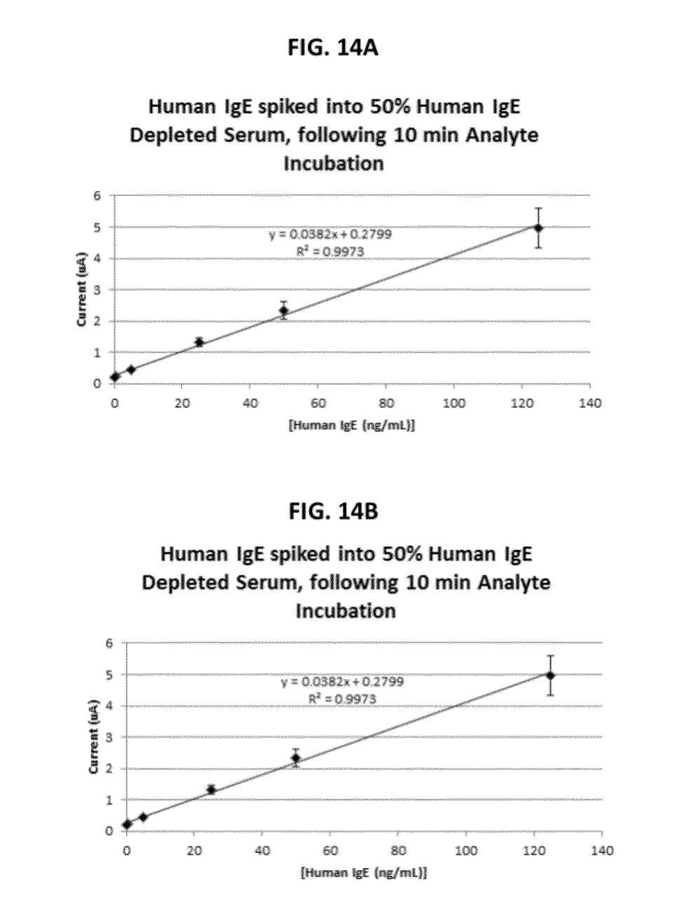

For the calibration curve (FIG. 14A), analyte standards of known concentration were created by dosing human IgE (Abcam) into a dilution of 1:2 IgE-depleted human serum (SCIPAC Ltd.):PBST. In triplicate, 50 μL of each standard was applied to wells on the array, and incubated for 10 minutes at room temperature.

For the biosensor arrays used to evaluate serum from allergy patients AARC0005 or AARC0017, their serum was diluted 1:2 in PBS buffer.

Next, wells were rinsed 3 times with PBST. Reporter solutions were prepared by diluting polyclonal goat anti-human IgE (c) HRP (KPL) to a concentration of 10 μg/mL in PBST. 50 μL of this solution was applied to each well on the array, and incubated for 30 minutes at room temperature. Wells were then rinsed 3 times with PBST.

The array was transferred to a Gamry potentiostat connector for recording electrochemical data. The potentiostat (Gamry Instruments Reference 600) was used to collect data in Step Amperometry mode. The array was connected to the potentiostat to form a 3-electrode electrochemical cell (a schematic of an exemplary 3 electrode electrochemical cell is show in FIG. 2B). PBST was removed from the well, and 50 μL of a 1:1 3,3′,5,5′-tetramethylbenzidine (TMB)/H₂O₂ solution (Pierce TMB substrate kit) was applied to the well. This was held for 10 seconds, and then a fixed bias of −0.400 V (vs. gold pseudo-reference) was held for 30 seconds, and current was measured in real time. The average current at time points between 28-30 seconds was recorded and used as a measure of signal. The average signal with standard deviation was plotted as a function of analyte dose concentration in the human serum dilution.

The result of the test with IgE standards is shown in FIG. 14A. The results of the test with human serum samples from allergy patients is shown in FIG. 14B. The allergen specific IgE values (ng/mL) were determined using the current values (μA) for the specific allergens and converting them to ng/mL using the formula shown in FIG. 14A (y=0.0382 x+0.2799).

In view of the many possible embodiments to which the principles of our invention may be applied, it should be recognized that illustrated embodiments are only examples of the invention and should not be considered a limitation on the scope of the invention. Rather, the scope of the invention is defined by the following claims. We therefore claim as our invention all that comes within the scope and spirit of these claims.

We claim:

1. A functionalized electrode, wherein the functionalized electrode comprises:
an electrically conducting surface;
a first thiol compound having the formula HS—(CH₂)x-(OCH₂CH₂)y-NH₂, or a salt thereof, wherein x is an integer ranging from 1-30 and y is an integer ranging from 0-10, and wherein the first thiol compound is bound to the electrically conducting surface through the reaction of the sulfhydryl moiety and wherein the first thiol is covalently linked to a ligand that specifically binds to a target analyte; and;
a second thiol compound having the formula HS—(CH₂)n-(OCH₂CH₂)m-R, wherein n is an integer ranging from 1-30 and m is an integer ranging from 0-10, R is selected from an OH, an alkoxy group, a CH₃, a sugar, a zwitterionic group, or a polar non-ionic group and wherein the second thiol compound is bound to the electrical conducting surface through the reaction of the sulfhydryl moiety present in the second thiol compound and the electrically conducting surface.

2. The functionalized electrode of claim 1:
(a) wherein the first thiol compound and the second thiol compound are presented as a heterodimer;
(b) wherein the first thiol compound is presented as a homodimer;
(c) wherein the second thiol compound is presented as a homodimer;
(d) wherein the first thiol compound is presented as a free sulfhydryl;
(e) wherein the second thiol compound is presented as a free sulfhydryl;
(f) or any combination of (a)-(e), and
wherein the thiols of the homodimer or the heterodimer are linked by a disulfide formed from the sulfhydryl moieties present in the thiols.

3. The functionalized electrode of claim 1, wherein the first thiol compound and the second thiol compound are present on the electrically conducting surface in a ratio of 0.01:99.99 to 99.99:0.01.

4. The functionalized electrode of claim 1, wherein the first thiol compound and the second thiol compound are present on the electrically conducting surface in a ratio of 0.1:99.9 to 10:90.

5. The functionalized electrode of claim 1, wherein n is an integer ranging from about 5 to about 15 and m is an integer ranging from about 3 to about 8.

6. The functionalized electrode of claim 1, wherein x is an integer ranging from about 5 to about 15 and y is an integer ranging from about 3 to about 8.

7. The functionalized electrode of claim 1, wherein the electrically conducting surface comprises a metal surface.

8. The functionalized electrode of claim 7, wherein the metal surface comprises a transition metal.

9. The functionalized electrode of claim 8, wherein the metal surface comprises gold.

10. The functionalized electrode of claim 1, wherein the ligand comprises an antibody, a protein, a peptide, a nucleic acid molecule, or a small molecule that specifically binds a target analyte.

11. The functionalized electrode of claim 1, wherein the target analyte comprises an antibody, a protein, a peptide, a nucleic acid molecule, or a small molecule.

12. The functionalized electrode of claim 1, wherein the linker comprises the reaction product of a heterobifunctional linker that comprise an amine reactive functionality, and present diazirine and or maleimide groups.

13. The functionalized electrode of claim 12, wherein the linker comprises the reaction product of a sulfosuccinimidyl-4-(N-maleimidomethyl)cyclohexane-1-carboxylate (Sulfo-SMCC) or sulfo-NHS diazirine (sulfo-SDA).

14. A biosensor, comprising the functionalized electrode of claim 1.

15. A biosensor array, comprising a plurality of biosensors of claim 14.

16. A kit, comprising:
the functionalized electrode of claim 1, a biosensor comprising the functionalized electrode of claim 1, or a biosensor array comprising a plurality of biosensors, wherein each biosensor comprises the functionalized electrode of claim 1;
a detection reagent; and
a substrate that is converted to an electroactive product by the detection reagent.

17. A system for detecting a target analyte, wherein the system comprises: a first electrode and an second electrode, wherein the first electrode is the functionalized electrode of claim 1; and
an electrochemical instrument capable of applying a controlled potential between the first and second electrode and measuring the current between the two electrodes.

18. The system of claim 17, wherein the second electrode is a common electrode.

19. The system of claim 17, further comprising a third electrode wherein the second electrode is a counter electrode and the third electrode is a reference electrode.

20. The method of claim 17, wherein the electrochemical instrument comprises a potentiostat, or a combination of multiple potentiostats.

21. A method of detecting a target analyte in a sample, comprising:
contacting a sample with the electrodes of the system of claim 17, wherein the functionalized electrode comprises a ligand that specifically binds to the target analyte;
contacting the electrodes with a detection reagent, wherein the detection reagent comprises a specific binding agent that specifically binds to the target analyte wherein the specific binding agent is not identical to the ligand that specifically binds to the target analyte and wherein the detection reagent comprises an enzyme that catalyzes a reaction with an enzyme substrate to produce an electroactive product;
contacting the electrodes with the an enzyme substrate to produce the electroactive product; and
measuring the current between the two electrodes, wherein detection of a change in current between the electrodes detects the target analyte in the sample.

22. A method of detecting a target analyte in a sample, comprising:
contacting a sample with the electrodes of the system of claim 17, wherein the functionalized electrode comprises a ligand that specifically binds to the target analyte;
contacting the electrodes with a detection reagent, wherein the detection reagent comprises a specific binding agent that specifically binds to ligand that specifically binds to the target analyte and wherein the detection reagent comprises an enzyme that catalyzes a reaction with an enzyme substrate to produce an electroactive product;
contacting the electrodes with the an enzyme substrate to produce the electroactive product; and
measuring the current between the two electrodes, wherein detection of a change in current between the electrodes detects the target analyte in the sample.

23. The method of claim 21, wherein the electroactive product is an electron acceptor.

24. The method of claim 21, wherein the electroactive product is an electron donor.

25. The method of claim 21, further comprising applying a controlled potential across the electrodes.

26. The method of claim 21, further comprising quantitating the target analyte in the sample.

27. The method of claim 21, wherein the electroactive product has a measurable cyclic voltammogram redox peak between about −1.5 V and about +1.5 V as measured versus a saturated calomel electrode.

28. The method of claim 21, wherein the enzyme is horseradish peroxidase and the enzyme substrate comprises a 1:1 3,3′,5,5′-tetramethylbenzidine (TMB)/H₂O₂ solution.

29. A method of making a functionalized electrode for detecting a target analyte, comprising:
contacting an electrically conducting surface with a mixture comprising a first thiol compound having the formula HS—(CH₂)ₓ—(OCH₂CH₂)_{y}—NH₂, or a salt thereof, wherein a is an integer ranging from 1-30 and b is an integer ranging from 0-10 and a second thiol compound having the formula HS—(CH₂)ₙ—(OCH₂CH₂)ₘ—R, wherein n is an integer ranging from 1-30 and m is an integer ranging from 0-10, R is selected from an OH, an alkoxy group, a CH₃, a sugar, a zwitterionic group, or a polar non-ionic group, wherein sulfhydryl groups on the first and second thiol compounds bond with the electrically conducting surface, thereby creating a monolayer on the surface of the electrically conducting surface;
contacting the monolayer on the surface of the electrically conducting surface with a heterobifunctional linker that comprises an amine reactive functionality, and a diazirine or maleimide moiety; and
contacting the monolayer on the surface of the electrically conducting surface with a ligand that specifically binds a target analyte, thereby making a functionalized electrode for detecting a target analyte.

30. The method of claim 29,
(a) wherein the first thiol compound and the second thiol compound are presented as a heterodimer;
(b) wherein the first thiol compound is presented as a homodimer;
(c) wherein the second thiol compound is presented as a homodimer;
(d) wherein the first thiol compound is presented as a free sulfhydryl;
(e) wherein the second thiol compound is presented as a free sulfhydryl;
(f) or any combination of (a)-(e), and wherein the thiols of the homodimer or the heterodimer are linked by a disulfide formed from the sulfhydryl moieties present in the thiols.

31. The method of claim 29, wherein the heterobifunctional linker comprises sulfo-NHS diazirine (sulfo-SDA), and the methods further comprises exposing the monolayer on the surface of the electrically conducting surface to ultra violet radiation, thereby making a functionalized electrode for detecting a target analyte.

32. The method of claim 29, wherein the heterobifunctional linker comprises sulfosuccinimidyl-4-(N-maleimidomethyl)cyclohexane-1-carboxylate (Sulfo-SMCC).

33. The method of claim 29, wherein the first thiol compound and the second thiol compound are present on the electrically conducting surface in a ratio of about 0.01:99.99 to about 99.99:0.01.

34. The method of claim 29, wherein n is an integer ranging from ranging from about 5 to about 15 and m is an integer ranging from about 3 to about 8.

35. The method of claim 29, wherein x is an integer ranging from about 5 to about 15 and y is an integer ranging from about 3 to about 8.

36. The method of claim 29, wherein the electrically conducting surface comprises a metal surface.

37. The method of claim 36, wherein the metal surface comprises a transition metal.

38. The method of claim 37, wherein the metal surface comprises gold.

39. The method of claim 29, wherein the specific binding agent comprises an antibody, a protein, a peptide, a nucleic acid molecule, or a small molecule that specifically binds a target analyte.

40. The method claim 29, wherein the target analyte comprises an antibody, a protein, a peptide, a nucleic acid molecule, or a small molecule.


SEQUENCE LISTING (1 sequence)

SEQ ID NO: 1 - protein, 17 aa, Artificial Sequence
  Synthetic peptide of epitope sequence from the wheat protein gliadin
KLQPFPQPELPYPQPQP